(19) United States
(12) Patent Application Publication
(10) Pub. No.: US 2013/0170450 A1
(43) Pub. Date: Jul. 4, 2013

(54) WIRELESS BROADCAST/MULTICAST SERVICE CAPACITY OVER DIFFERENT LINK BUDGETS AND OVERLAY NETWORKS

(71) Applicant: QUALCOMM Incorporated, San Diego, CA (US)

(72) Inventors: Kirankumar Anchan, San Diego, CA (US); Mark Maggenti, San Diego, CA (US); Lin-Yih Hao, Santa Clara, CA (US)

(73) Assignee: QUALCOMM INCORPORATED, San Diego, CA (US)

(21) Appl. No.: 13/726,602

(22) Filed: Dec. 25, 2012

Related U.S. Application Data
(60) Provisional application No. 61/581,579, filed on Dec. 29, 2011.

(51) Int. Cl. H04W 4/06

(52) U.S. Cl. CPC H04W 4/06
USPC 370/329

(57) ABSTRACT

In an embodiment, an application server determines to transmit a first data stream in a first multicasting area, a second data stream in a second multicasting area and both data streams in a third multicasting area that overlaps with the second multicasting area (e.g., at a border region between the first and second multicasting areas). The application server sends the first data stream to a multicast network management node for transmission in the first and third multicasting areas. The application server sends the first and second data streams to a multiplex stream multiplexer that multiplexes the two data streams into a single higher-rate multiplexed multicast stream with packets that include payloads data for both the first and second data streams. The multiplexed multicast stream is delivered to the third multicasting area for transmission to at least one target UE.

### CLAIM OF PRIORITY UNDER 35 U.S.C. §119

The present application for patent claims priority to Provisional Application No. 61/581,579 entitled “SELECTIVELY MULTIPLEXING COMMUNICATION STREAMS OVER EVOLVED MULTIMEDIA BROADCAST/MULTICAST SERVICES”, filed Dec. 29, 2011, and assigned to the assignee hereof and hereby expressly incorporated by reference herein.

### CROSS REFERENCE TO RELATED APPLICATIONS

The present application for patent is also related to U.S. application No. UNKNOWN, entitled “SELECTIVELY MULTIPLEXING COMMUNICATION STREAMS”, filed on the same date as the subject application, having attorney docket no. 120865, assigned to the assignee hereof and hereby expressly incorporated by reference herein.

### FIELD OF DISCLOSURE

The present disclosure relates generally to communication, and more specifically to techniques for selectively multiplexing group communication streams for broadcast and multicast services in a cellular communication system.

### BACKGROUND

A cellular communication system can support bi-directional communication for multiple users by sharing the available system resources. Cellular systems are different from broadcast systems that can mainly or only support unidirectional transmission from broadcast stations to users. Cellular systems are widely deployed to provide various communication services and may be multiple-access systems such as Code Division Multiple Access (CDMA) systems, Time Division Multiple Access (TDMA) systems, Frequency Division Multiple Access (FDMA) systems, Orthogonal FDMA (OFDMA) systems, Single-Carrier FDMA (SC-FDMA) systems, etc.

A cellular system may support broadcast, multicast, and unicast services. A broadcast service is a service that may be received by all users, e.g., news broadcast. A multicast service is a service that may be received by a group of users, e.g., a subscription video service. A unicast service is a service intended for a specific user, e.g., voice call. Group communications can be implemented using unicast, broadcast, multicast or a combination thereof. As the group becomes larger it is generally more efficient to use multicast services. However, for group communication services that require low latency and a short time to establish the group communication, the setup time of conventional multicast channels can be a detriment to system performance.

### SUMMARY

In an embodiment, an application server determines to transmit a first data stream in a first multicasting area, a second data stream in a second multicasting area and both data streams in a third multicasting area that overlaps with the second multicasting area (e.g., at a border region between the first and second multicasting areas). The application server sends the first data stream to a multicast network management node for transmission in the first and third multicasting areas. The application server sends the first and second data streams to a multiplex stream multiplexer that multiplexes the two data streams into a single higher-rate multiplexed multicast stream with packets that include payloads data for both the first and second data streams. The multiplexed multicast stream is delivered to the third multicasting area for transmission to at least one target UE.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a wireless communication system.

FIG. 2 illustrates an example transmission structure.

FIG. 3 illustrates example transmissions of different services in a multi-cell mode.

FIG. 4 illustrates example transmissions of different services in a single-cell mode.

FIGS. 5A and 5B illustrate additional wireless communication systems that can support broadcast/multicast services.

FIG. 6 illustrates a block diagram of a portion of a wireless communication system that can support broadcast/multicast services.

FIG. 7 illustrates a communication device in accordance with an embodiment of the present invention.

FIG. 8 illustrates an example interface between a set of application servers and a broadcast multicast service center in accordance with an embodiment of the invention.

FIGS. 9A and 9B illustrate an example of multiplexing data associated with different data streams onto a single multicast stream in accordance with an embodiment of the present invention.

FIGS. 10A through 10D illustrate conventional multicast stream delivery procedures, whereby multicast streams are delivered without multiplexing streams together within common UDP/IP packets.

FIGS. 11A through 11D are directed to implementations whereby multicast stream multiplexing is used to achieve, in certain instances, single sub frame allocations for multiple E-MBMS services and also to achieve disparate data rate support for a single E-MBMS service across a serving area with different capacity support levels in accordance with an embodiment of the invention.

FIG. 12 illustrates a process of generating and disseminating multiplexed and non-multiplexed data packets in accordance with another embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation. Further, as used herein the term group communication, push-to-talk, or similar variations are meant to refer to a server arbitrated service between two or more devices.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The techniques described herein may be used for various cellular communication systems such as CDMA, TDMA, FDMA, OFDMA and SC-FDMA systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for LTE, and LTE terminology is used in much of the description below.

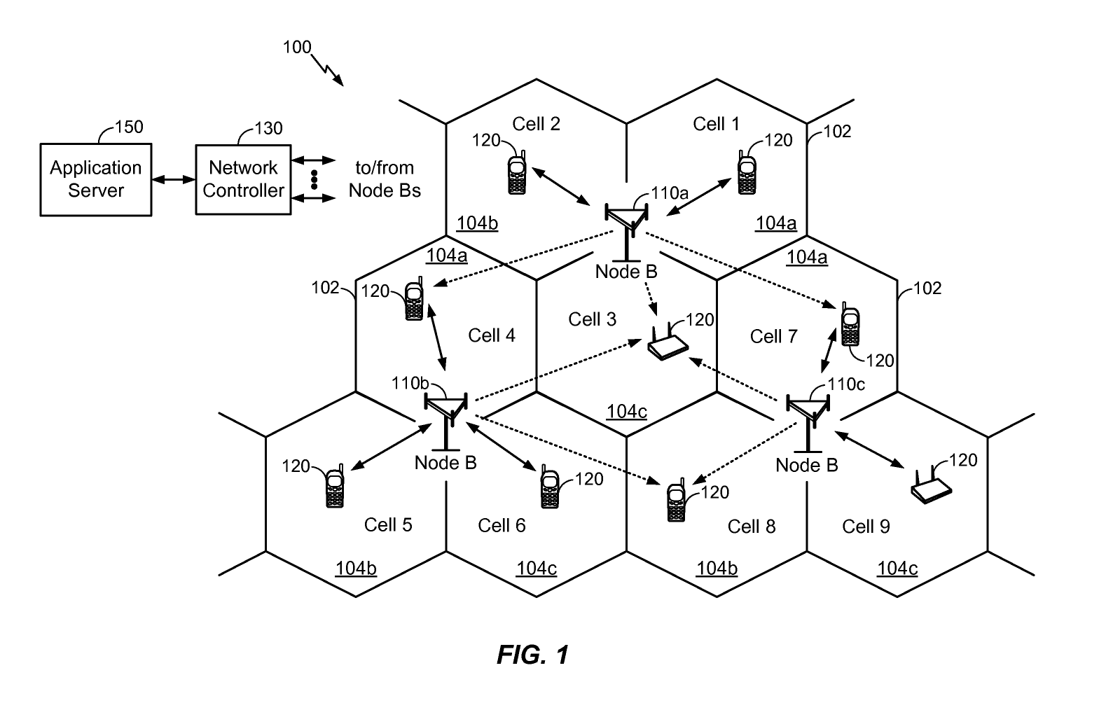

FIG. 1 shows a cellular communication system 100, which may be an LTE system. System 100 may include a number of Node Bs and other network entities. For simplicity, only three Node Bs 110a, 110b and 110c are shown in FIG. 1. A Node B may be a fixed station used for communicating with the user equipments (UEs) and may also be referred to as an evolved Node B (eNB), a base station, an access point, etc. Each Node B 110 provides communication coverage for a particular geographic area 102. To improve system capacity, the overall coverage area of a Node B may be partitioned into multiple smaller areas, e.g., three smaller areas 104a, 104b and 104c. Each smaller area may be served by a respective Node B subsystem. In 3GPP, the term “cell” can refer to the smallest coverage area of a Node B and/or a Node B subsystem serving this coverage area. In other systems, the term “sector” can refer to the smallest coverage area of a base station and/or a base station subsystem serving this coverage area. For clarity, 3GPP concept of a cell is used in the description below.

In the example shown in FIG. 1, each Node B 110 has three cells that cover different geographic areas. For simplicity, FIG. 1 shows the cells not overlapping one another. In a practical deployment, adjacent cells typically overlap one another at the edges, which may allow a UE to receive coverage from one or more cells at any location as the UE moves about the system.

UEs 120 may be dispersed throughout the system, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, etc. A UE may communicate with a Node B via transmissions on the downlink and uplink. The downlink (or forward link) refers to the communication link from the Node B to the UE, and the uplink (or reverse link) refers to the communication link from the UE to the Node B. In FIG. 1, a solid line with double arrows indicates bi-directional communication between a Node B and a UE. A dashed line with a single arrow indicates a UE receiving a downlink signal from a Node B, e.g., for broadcast and/or multicast services. The terms “UE” and “user” are used interchangeably herein.

Network controller 130 may couple to multiple Node Bs to provide coordination and control for the Node Bs under its control, and to route data for terminals served by these Node Bs. Access network 100 may also include other network entities not shown in FIG. 1. Further, as illustrated network controller may be operably coupled to an application server 150 to provide group communication services to the various UEs 120 through access network 100. It will be appreciated that there can be many other network and system entities that can be used to facilitate communications between the UEs and servers and information outside of the access network. Accordingly, the various embodiments disclosed herein are not limited to the specific arrangement or elements detailed in the various figures.

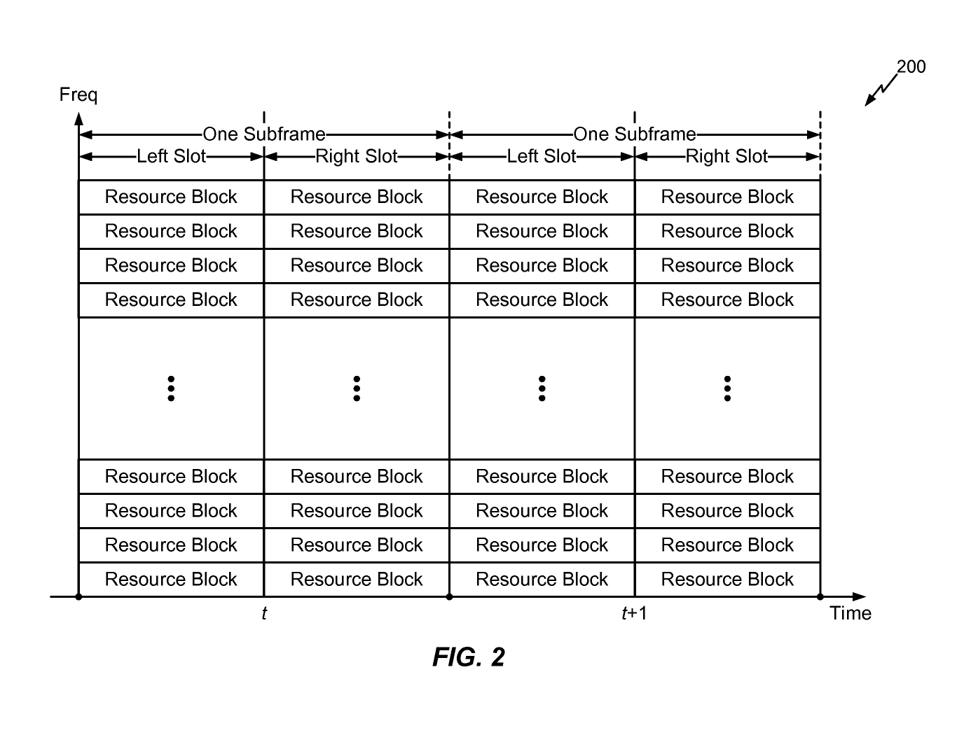

FIG. 2 shows an example transmission structure 200 that may be used for the downlink in system 100. The transmission timeline may be partitioned into units of radio frames. Each radio frame may have a predetermined duration (e.g., 10 milliseconds (ms)) and may be partitioned into 10 sub frames. Each sub frame may include two slots, and each slot may include a fixed or configurable number of symbol periods, e.g., six or seven symbol periods.

The system bandwidth may be partitioned into multiple (K) subcarriers with orthogonal frequency division multiplexing (OFDM). The available time frequency resources may be divided into resource blocks. Each resource block may include Q subcarriers in one slot, where Q may be equal to 12 or some other value. The available resource blocks may be used to send data, overhead information, pilot, etc.

The system may support evolved multimedia broadcast/multicast services (E-MBMS) for multiple UEs as well as unicast services for individual UEs. A service for E-MBMS may be referred to as an E-MBMS service or flow and may be a broadcast service/flow or a multicast service/flow.

In LTE, data and overhead information are processed as logical channels at a Radio Link Control (RLC) layer. The logical channels are mapped to transport channels at a Medium Access Control (MAC) layer. The transport channels are mapped to physical channels at a physical layer (PHY). Table 1 lists some logical channels (denoted as “L”), transport channels (denoted as “T”), and physical channels (denoted as “P”) used in LTE and provides a short description for each channel.

TABLE 1

| Name | Channel | Type | Description |
|---|---|---|---|
| Broadcast Control | BCCH | L | Carry system information |
| Channel | | | |
| Broadcast Channel | BCH | T | Carry master system Information |
| E-MBMS Traffic | MTCH | L | Carry configuration information |
| Channel | | | for E-MBMS services. |
| Multicast Channel | MCH | T | Carry the MTCH and MCCH |
| Downlink Shared | DL-SCH | T | Carry the MTCH and other |
| Channel | | | logical channels |
| Physical Broadcast | PBCH | P | Carry basic system information |
| Channel | | | for use in acquiring the system. |
| Physical Multicast | PMCH | P | Carry the MCH. |
| Channel | | | |
| Physical Downlink | PDSCH | P | Carry data for the DL-SCH |
| Shared Channel | | | |
| Physical Downlink | PDCCH | P | Carry control information for the |
| Control Channel | | | DL-SCH |

As shown in Table 1, different types of overhead information may be sent on different channels. Table 2 lists some types of overhead information and provides a short description for each type. Table 2 also gives the channel(s) on which each type of overhead information may be sent, in accordance with one design.

TABLE 2

| Overhead | | |
|---|---|---|
| Information | Channel | Description |
| System | BCCH | Information pertinent for communicating |
| Information | | with and/or receiving data from the system. |
| Configuration | MCCH | Information used to receive the Information |
| Information | | services, e.g., MBSFN Area Configuration, |
| | | which contains PMCH configurations, |
| | | Service ID, Session ID, etc. |
| Control | PDCCH | Information used to receive Information |
| Information | | transmissions of data for the services, e.g., |
| | | resource assignments, modulation and |
| | | coding schemes, etc. |

The different types of overhead information may also be referred to by other names. The scheduling and control information may be dynamic whereas the system and configuration information may be semi-static.

The system may support multiple operational modes for E-MBMS, which may include a multi-cell mode and a single-cell mode. The multi-cell mode may have the following characteristics:
Content for broadcast or multicast services can be transmitted synchronously across multiple cells.
Radio resources for broadcast and multicast services are allocated by an MBMS Coordinating Entity (MCE), which may be logically located above the Node Bs.
Content for broadcast and multicast services is mapped on the MCH at a Node B.
Time division multiplexing (e.g., at sub frame level) of data for broadcast, multicast, and unicast services.

The single-cell mode may have the following characteristics:
Each cell transmits content for broadcast and multicast services without synchronization with other cells.
Radio resources for broadcast and multicast services are allocated by the Node B.
Content for broadcast and multicast services is mapped on the DL-SCH.
Data for broadcast, multicast, and unicast services may be multiplexed in any manner allowed by the structure of the DL-SCH.

In general, E-MBMS services may be supported with the multi-cell mode, the single-cell mode, and/or other modes. The multi-cell mode may be used for E-MBMS multicast/broadcast single frequency network (MBSFN) transmission, which may allow a UE to combine signals received from multiple cells in order to improve reception performance.

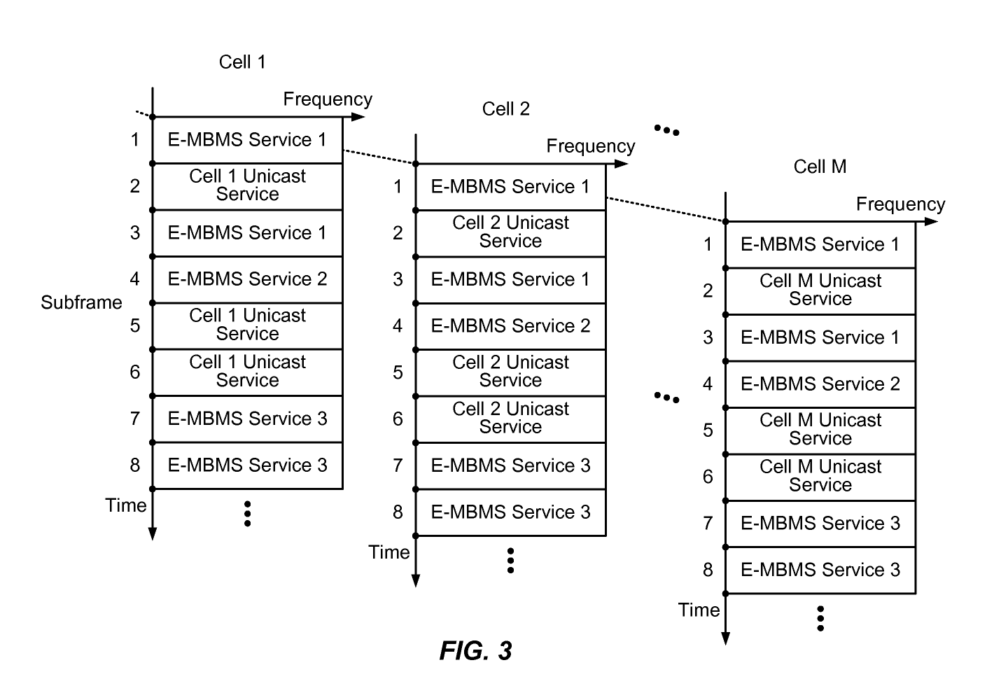

FIG. 3 shows example transmissions of E-MBMS and unicast services by M cells 1 through M in the multi-cell mode, where M may be any integer value. For each cell, the horizontal axis may represent time, and the vertical axis may represent frequency. In one design of E-MBMS, which is assumed for much of the description below, the transmission time line for each cell may be partitioned into time units of sub frames. In other designs of E-MBMS, the transmission time line for each cell may be partitioned into time units of other durations. In general, a time unit may correspond to a sub frame, a slot, a symbol period, multiple symbol periods, multiple slots, multiple sub frames, etc.

In the example shown in FIG. 3, the M cells transmit three E-MBMS services 1, 2 and 3. All M cells transmit E-MBMS service 1 in sub frames 1 and 3, E-MBMS service 2 in sub frame 4, and E-MBMS service 3 in sub frames 7 and 8. The M cells transmit the same content for each of the three E-MBMS services. Each cell may transmit its own unicast service in sub frames 2, 5 and 6. The M cells may transmit different contents for their unicast services.

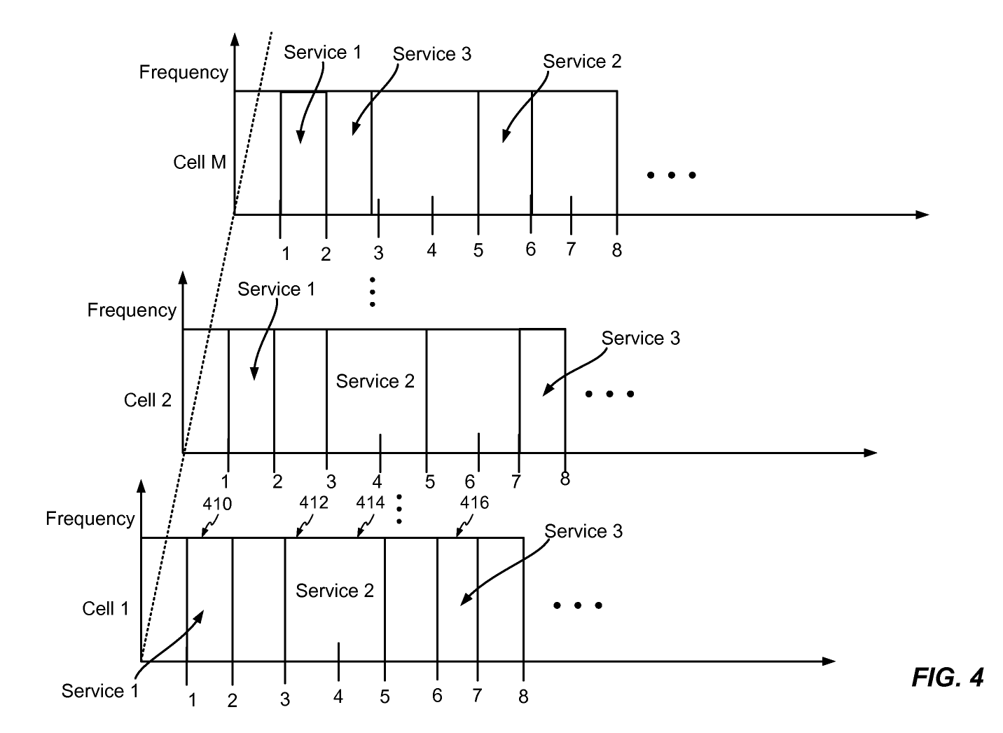

FIG. 4 shows example transmissions of E-MBMS and unicast services by M cells in the single-cell mode. For each cell, the horizontal axis may represent time, and the vertical axis may represent frequency. In the example shown in FIG. 4, the M cells transmit three E-MBMS services 1, 2 and 3. Cell 1 transmits E-MBMS service 1 in one time frequency block 410, E-MBMS service 2 in a time frequency blocks 412 and 414, and E-MBMS service 3 in one time frequency blocks 416. Similarly other cells transmit services 1, 2 and 3 as shown in the FIG. 4.

In general, an E-MBMS service may be sent in any number of time frequency blocks. The number of sub frames may be dependent on the amount of data to send and possibly other factors. The M cells may transmit the three E-MBMS services 1, 2 and 3 in time frequency blocks that may not be aligned in time and frequency, as shown in FIG. 4. Furthermore, the M cells may transmit the same or different contents for the three E-MBMS services. Each cell may transmit its own unicast service in remaining time frequency resources not used for the three E-MBMS services. The M cells may transmit different contents for their unicast services.

FIGS. 3 and 4 show example designs of transmitting E-MBMS services in the multi-cell mode and the single-cell mode. E-MBMS services may also be transmitted in other manners in the multi-cell and single-cell modes, e.g., using time division multiplexing (TDM).

As noted in the foregoing, E-MBMS services can be used to distribute multicast data to groups and could be useful in group communication systems (e.g., Push-to-Talk (PTT) calls). Conventional applications on E-MBMS have a separate service announcement/discovery mechanism. Further, communications on pre-established E-MBMS flows are always on even on the air interface. Power saving optimization must be applied to put the UE to sleep when a call/communication is not in progress. This is typically achieved by using out of band service announcements on unicast or multicast user plane data. Alternatively application layer paging channel like mechanism may be used. Since the application layer paging mechanism has to remain active, it consumes bandwidth on the multicast sub-frame which could be idle in the absence of the paging mechanism. Additionally, since the multicast sub-frame will be active while using the application layer paging, the remainder of the resource blocks within the sub frame cannot be used for unicast traffic. Thus the total 5 Mhz bandwidth will be consumed for the sub frame for instances when application layer paging is scheduled without any other data.

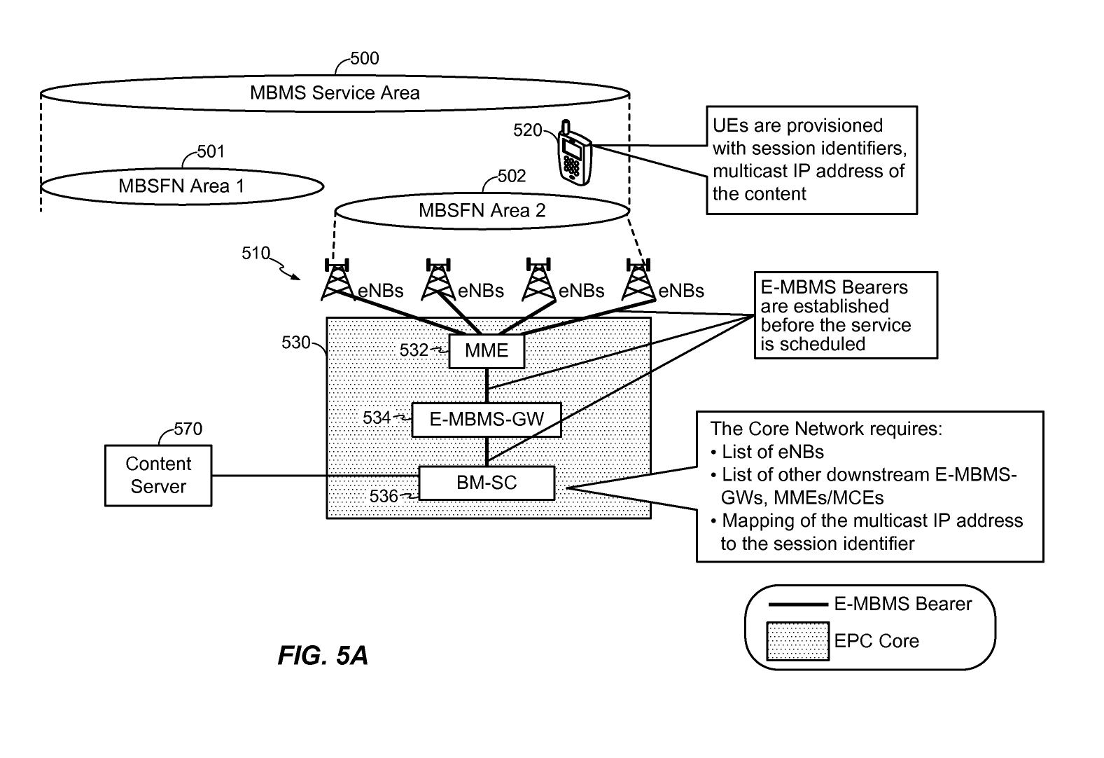

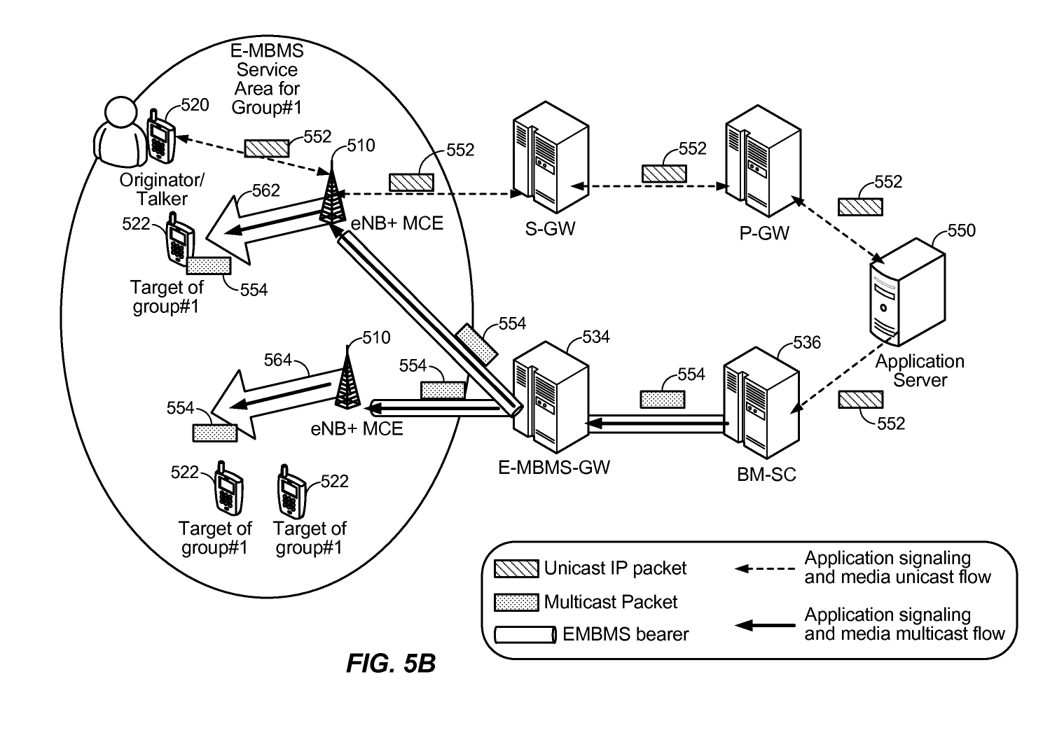

FIG. 5A is another illustration of a wireless network that can implement evolved multimedia broadcast/multicast services (E-MBMS) or MBMS services, which are used interchangeably herein. An MBMS service area 500 can include multiple MBSFN areas (e.g. MBSFN area 1, 501 and MBSFN area 2, 502). Each MBSFN area can be supported by one or more eNode Bs 510, which are coupled to a core network 530. Core network 520 can include various elements (e.g., MME 532, E-MBMS gateway 534, and broadcast multicast service center (BM-SC) 536 to facilitate controlling and distributing the content from content provider 570 (which may include an application server, etc.) to the MBMS service area 500.

FIG. 5B is another illustration of a wireless network that can implement multimedia broadcast/multicast services (MBMS) as disclosed herein. In the illustrated network an application server 550 (e.g., PTT server) can serve as the content server. The application server 550 can communicate media in unicast packets 552 to the network core where the content can be maintained in a unicast configuration and transmitted as unicast packets to a given UE (e.g., originator/talker 520) or can be converted through the BM-SC 536 to multicast packets 554, which can then be transported target UE's 522. For example, a PTT call can be initiated by UE 520 by communicating with application server 550 via unicast packets 552 over a unicast channel. It will be noted that for the call originator/call talker both the application signaling and media are communicated via the unicast channel on the uplink or the reverse link. The application server 550 can then generate a call announce/call setup request and communicate these to the target UEs 522. The communication can be communicated to the target UEs 522 via multicast packets 554 over a multicast flow, as illustrated in this particular example. Further, it will be appreciated in this example, that both the application signaling and media can be communicated over the multicast flow in the downlink or the forward link. Unlike conventional systems, having both the application signaling and the media in the multicast flow, avoids the need of having a separate unicast channel for the application signaling. However, to allow for application signaling over the multicast flow of the illustrated system, an evolved. packet system (EPS) bearer will be established (and persistently on) between the BM-SC 536, EMBS GW 534, eNBs 510 and target UEs 522.

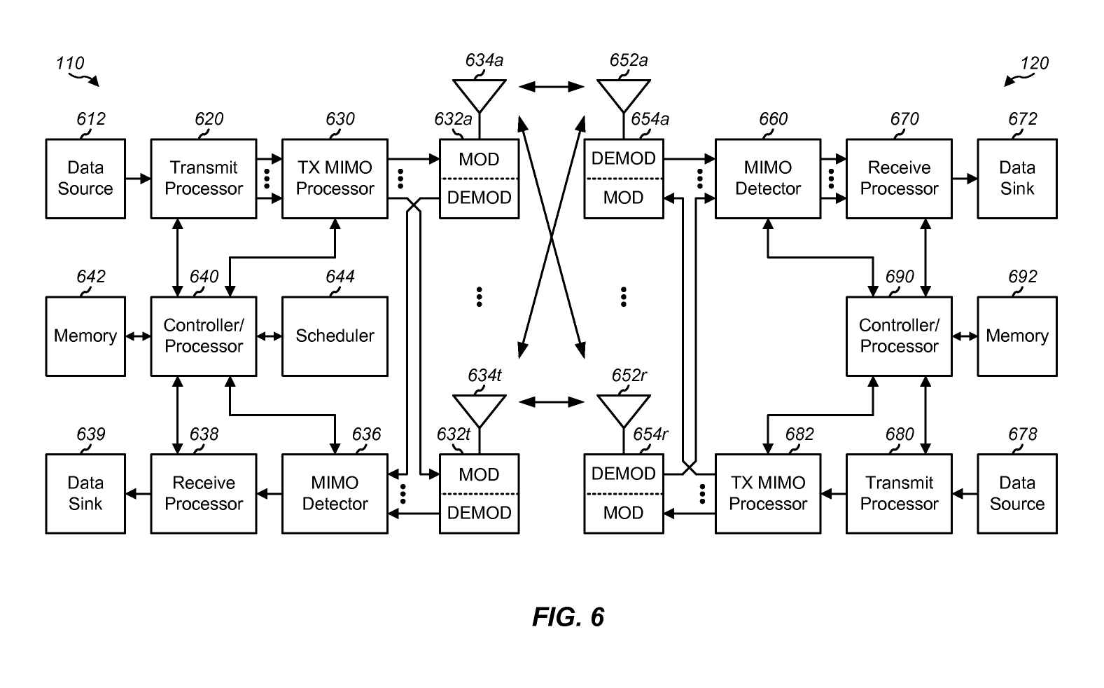

In accordance with various embodiments disclosed herein some of the downlink channels related to E-MBMS will be further discussed, which include.
MCCH: Multicast Control Channel;
MTCH: Multicast Traffic Channel;
MCH: Multicast Channel; and
PMCH: Physical Multicast Channel.
   It will be appreciated that multiplexing of E-MBMS and unicast flows are realized in the time domain only. The MCH is transmitted over MBSFN in specific sub frames on physical layer. MCH is a downlink only channel. A single transport block is used per sub frame. Different services (MTCHs) can be multiplexed in this transport block, as will be illustrated in relation to FIG. 6.

To achieve low latency and reduce control signaling, one E-MBMS flow (562, 564) can be activated for each service area. Depending on the data rate, multiple multicast flows can be multiplexed on a single slot. PTT UEs (targets) can ignore and “sleep” between scheduled sub frames and reduce power consumption when no unicast data is scheduled for the UE. The MBSFN sub frame can be shared by groups in the same MBSFN service area. MAC layer signaling can be leveraged to “wake-up” the application layer (e.g., PTT application) for the target UEs.

Embodiments can use two broadcast streams, each a separate E-MBMS flow over an LTE broadcast flow, with its own application level broadcast stream and its own (multicast IP address) for each defined broadcast region 502, 501 (e.g., a subset of sectors within the network). Although illustrated as separate regions, it will be appreciated that the broadcast areas 502, 501 may overlap.

In LTE, the control and data traffic for multicast is delivered over MCCH and MTCH, respectively. The Medium Access Control Protocol Data Units (MAC PDUs) for the UEs indicate the mapping of the MTCH and the location of a particular MTCH within a sub frame. An MCH Scheduling Information (MSI) MAC control element is included in the first sub frame allocated to the MCH within the MCH scheduling period to indicate the position of each MTCH and unused sub frames on the MCH. For E-MBMS user data, which is carried by the MTCH logical channel, MCH scheduling information (MSI) periodically provides at lower layers (e.g., MAC layer information) the information on decoding the MTCH. The MSI scheduling can be configured and according to this embodiment is scheduled prior to MTCH sub-frame interval.

FIG. 6 illustrates a block diagram of a design of an eNode B 110 and UE 120, which may be one of the eNode Bs and one of the UEs discussed herein in relation to the various embodiments. In this design, Node B 110 is equipped with T antennas 634a through 634t, and UE 120 is equipped with R antennas 652a through 652r, where in general T is greater than or equal to 1 and R is greater than or equal to 1.

At Node B 110, a transmit processor 620 may receive data for unicast services and data for broadcast and/or multicast services from a data source 612 (e.g., directly or indirectly from application server 150). Transmit processor 620 may process the data for each service to obtain data symbols. Transmit processor 620 may also receive scheduling information, configuration information, control information, system information and/or other overhead information from a controller/processor 640 and/or a scheduler 644. Transmit processor 620 may process the received overhead information and provide overhead symbols. A transmit (TX) multiple-input multiple-output (MIMO) processor 630 may multiplex the data and overhead symbols with pilot symbols, process (e.g., precode) the multiplexed symbols, and provide T output symbol streams to T modulators (MOD) 632a through 632t. Each modulator 632 may process a respective output symbol stream (e.g., for OFDM) to obtain an output sample stream. Each modulator 632 may further process (e.g., convert to analog, amplify, filter, and upconvert) the output sample stream to obtain a downlink signal. T downlink signals from modulators 632a through 632t may be transmitted via T antennas 634a through 634t, respectively.

At UE 120, antennas 652a through 652r may receive the downlink signals from Node B 110 and provide received signals to demodulators (DEMOD) 654a through 654r, respectively. Each demodulator 654 may condition (e.g., filter, amplify, downconvert, and digitize) a respective received signal to obtain received samples and may further process the received samples (e.g., for OFDM) to obtain received symbols. A MIMO detector 660 may receive and process the received symbols from all R demodulators 654a through 654r and provide detected symbols. A receive processor 670 may process the detected symbols, provide decoded data for UE 120 and/or desired services to a data sink 672, and provide decoded overhead information to a controller/processor 690. In general, the processing by MIMO detector 660 and receive processor 670 is complementary to the processing by TX MIMO processor 630 and transmit processor 620 at Node B 110.

On the uplink, at UE 120, data from a data source 678 and overhead information from a controller/processor 690 may be processed by a transmit processor 680, further processed by a TX MIMO processor 682 (if applicable), conditioned by modulators 654a through 654r, and transmitted via antennas 652a through 652r. At Node B 110, the uplink signals from UE 120 may be received by antennas 634, conditioned by demodulators 632, detected by a MIMO detector 636, and processed by a receive processor 638 to obtain the data and overhead information transmitted by UE 120.

Controllers/processors 640 and 690 may direct the operation at Node B 110 and UE 120, respectively. Scheduler 644 may schedule UEs for downlink and/or uplink transmission, schedule transmission of broadcast and multicast services, and provide assignments of radio resources for the scheduled UEs and services. Controller/processor 640 and/or scheduler 644 may generate scheduling information and/or other overhead information for the broadcast and multicast services.

Controller/processor 690 may implement processes for the techniques described herein. Memories 642 and 692 may store data and program codes for Node B 110 and UE 120, respectively.

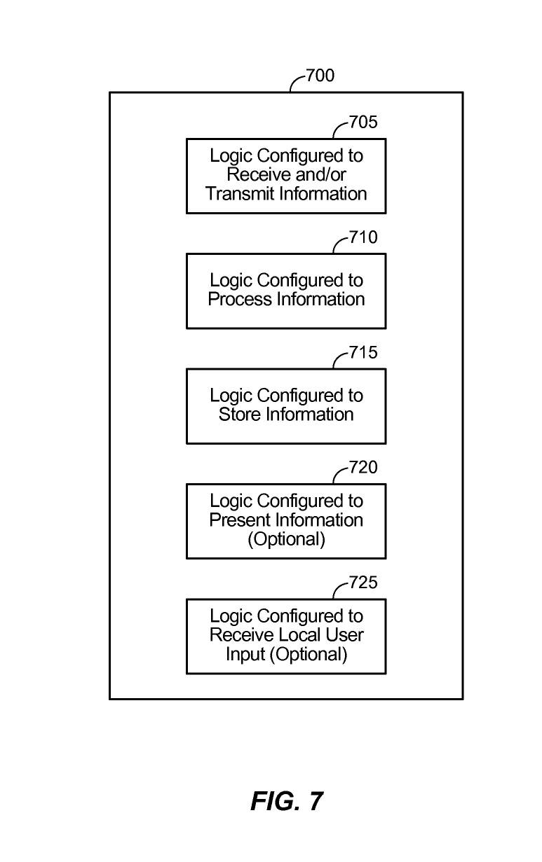

FIG. 7 illustrates a communication device 700 that includes logic configured to perform functionality. The communication device 700 can correspond to any of the above-noted communication devices, including but not limited to Node Bs 110 or 510, UEs 120 or 520, the application server 150, the network controller 130, the BM-SC 536, the content server 570, MME 532, E-MBMS-GW 532, etc. Thus, communication device 700 can correspond to any electronic device that is configured to communicate with (or facilitate communication with) one or more other entities over a network.

Referring to FIG. 7, the communication device 700 includes logic configured to receive and/or transmit information 705. In an example, if the communication device 700 corresponds to a wireless communications device (e.g., UE 120, Node B 110, etc.), the logic configured to receive and/or transmit information 705 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 705 can correspond to a wired communications interface (e.g., a serial connection, a USB or Firewire connection, an Ethernet connection through which the Internet 175 can be accessed, etc.). Thus, if the communication device 700 corresponds to some type of network-based server (e.g., the application server 150, the network controller 130, the BM-SC 536, the content server 570, MME 532, E-MBMS-GW 532, etc.), the logic configured to receive and/or transmit information 705 can correspond to an Ethernet card, in an example, that connects the network-based server to other communication entities via an Ethernet protocol. In a further example, the logic configured to receive and/or transmit information 705 can include sensory or measurement hardware by which the communication device 700 can monitor its local environment (e.g., an accelerometer, a temperature sensor, a light sensor, an antenna for monitoring local RF signals, etc.). The logic configured to receive and/or transmit information 705 can also include software that, when executed, permits the associated hardware of the logic configured to receive and/or transmit information 705 to perform its reception and/or transmission function(s). However, the logic configured to receive and/or transmit information 705 does not correspond to software alone, and the logic configured to receive and/or transmit information 705 relies at least in part upon hardware to achieve its functionality.

Referring to FIG. 7, the communication device 700 further includes logic configured to process information 710. In an example, the logic configured to process information 710 can include at least a processor. Example implementations of the type of processing that can be performed by the logic configured to process information 710 includes but is not limited to performing determinations, establishing connections, making selections between different information options, performing evaluations related to data, interacting with sensors coupled to the communication device 700 to perform measurement operations, converting information from one format to another (e.g., between different protocols such as .wmv to .avi, etc.), and so on. For example, the processor included in the logic configured to process information 710 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 710 can also include software that, when executed, permits the associated hardware of the logic configured to process information 710 to perform its processing function(s). However, the logic configured to process information 710 does not correspond to software alone, and the logic configured to process information 710 relies at least in part upon hardware to achieve its functionality.

Referring to FIG. 7, the communication device 700 further includes logic configured to store information 715. In an example, the logic configured to store information 715 can include at least a non-transitory memory and associated hardware (e.g., a memory controller, etc.). For example, the non-transitory memory included in the logic configured to store information 715 can correspond to RAM memory, flash memory, ROM memory, EPROM memory, EEPROM memory, registers, hard disk, a removable disk, a CD-ROM, or any other form of storage medium known in the art. The logic configured to store information 715 can also include software that, when executed, permits the associated hardware of the logic configured to store information 715 to perform its storage function(s). However, the logic configured to store information 715 does not correspond to software alone, and the logic configured to store information 715 relies at least in part upon hardware to achieve its functionality.

Referring to FIG. 7, the communication device 700 further optionally includes logic configured to present information 720. In an example, the logic configured to display information 720 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 700. For example, if the communication device 700 corresponds to UE 120 or 520, the logic configured to present information 720 can include a display screen and an audio output device (e.g., speakers). In a further example, the logic configured to present information 720 can be omitted for certain communication devices, such as network communication devices that do not have a local user (e.g., network switches or routers, remote servers, etc.). The logic configured to present information 720 can also include software that, when executed, permits the associated hardware of the logic configured to present information 720 to perform its presentation function(s). However, the logic configured to present information 720 does not correspond to software alone, and the logic configured to present information 720 relies at least in part upon hardware to achieve its functionality.

Referring to FIG. 7, the communication device 700 further optionally includes logic configured to receive local user input 725. In an example, the logic configured to receive local user input 725 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 700. For example, if the communication device 700 corresponds to UE 120 or 520, the logic configured to receive local user input 725 can include a display screen (if implemented a touch-screen), a keypad, etc. In a further example, the logic configured to receive local user input 725 can be omitted for certain communication devices, such as network communication devices that do not have a local user (e.g., network switches or routers, remote servers, etc.). The logic configured to receive local user input 725 can also include software that, when executed, permits the associated hardware of the logic configured to receive local user input 725 to perform its input reception function(s). However, the logic configured to receive local user input 725 does not correspond to software alone, and the logic configured to receive local user input 725 relies at least in part upon hardware to achieve its functionality.

Referring to FIG. 7, while the configured logics of 705 through 725 are shown as separate or distinct blocks in FIG. 7, it will be appreciated that the hardware and/or software by which the respective configured logic performs its functionality can overlap in part. For example, any software used to facilitate the functionality of the configured logics of 705 through 725 can be stored in the non-transitory memory associated with the logic configured to store information 715, such that the configured logics of 705 through 725 each performs their functionality (i.e., in this case, software execution) based in part upon the operation of software stored by the logic configured to store information 705. Likewise, hardware that is directly associated with one of the configured logics can be borrowed or used by other configured logics from time to time. For example, the processor of the logic configured to process information 710 can format data into an appropriate format before being transmitted by the logic configured to receive and/or transmit information 705, such that the logic configured to receive and/or transmit information 705 performs its functionality (i.e., in this case, transmission of data) based in part upon the operation of hardware (i.e., the processor) associated with the logic configured to process information 710. Further, the configured logics or “logic configured to” of 705 through 725 are not limited to specific logic gates or elements, but generally refer to the ability to perform the functionality describe herein (either via hardware or a combination of hardware and software). Thus, the configured logics or “logic configured to” of 705 through 725 are not necessarily implemented as logic gates or logic elements despite sharing the word “logic”. Other interactions or cooperation between the configured logics 705 through 725 will become clear to one of ordinary skill in the art from a review of the embodiments described below in more detail.

Conventionally, different streams in an E-MBMS service over cellular/wireless networks share over the air (OTA) resources and network links. Given the knowledge that multiple streams having a common link, embodiments of the present invention are directed to leveraging network and application layer techniques to improve bandwidth efficiency and to improve the application payload or the number of application streams within the same bandwidth.

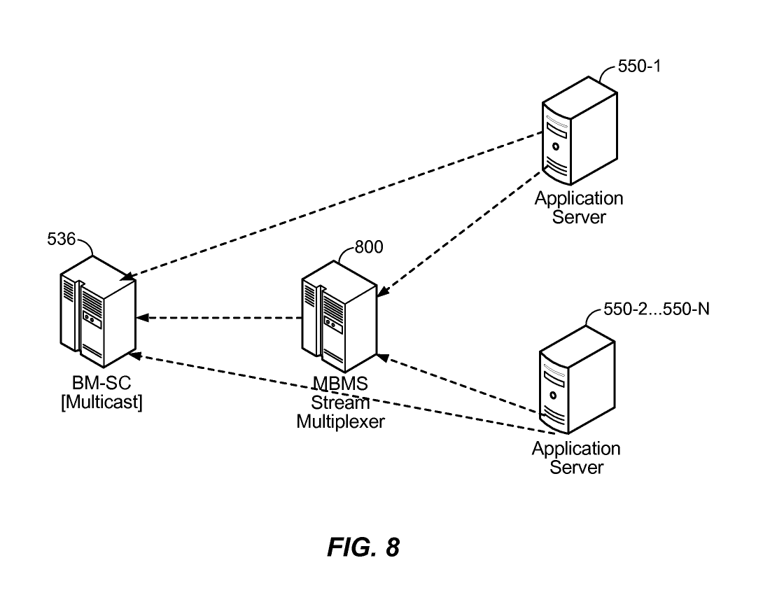

FIG. 8 illustrates an example interface between the application server 550 and the BM-SC 536 in accordance with an embodiment of the invention. In particular, in FIG. 8, the application server 550 from FIG. 5B is illustrated as a plurality of different application servers 550-1 . . . 550-N, where N>1. Each of the application servers 550-1 . . . 550-N is associated with a different E-MBMS service. For example, application server 550-1 may be configured to support a dispatch service for emergency responders in a given geographic area, application server 550-2 may be configured to support delivery of media content programs or channels in a given geographic area (e.g., ESPN, HBO, etc.), and so on.

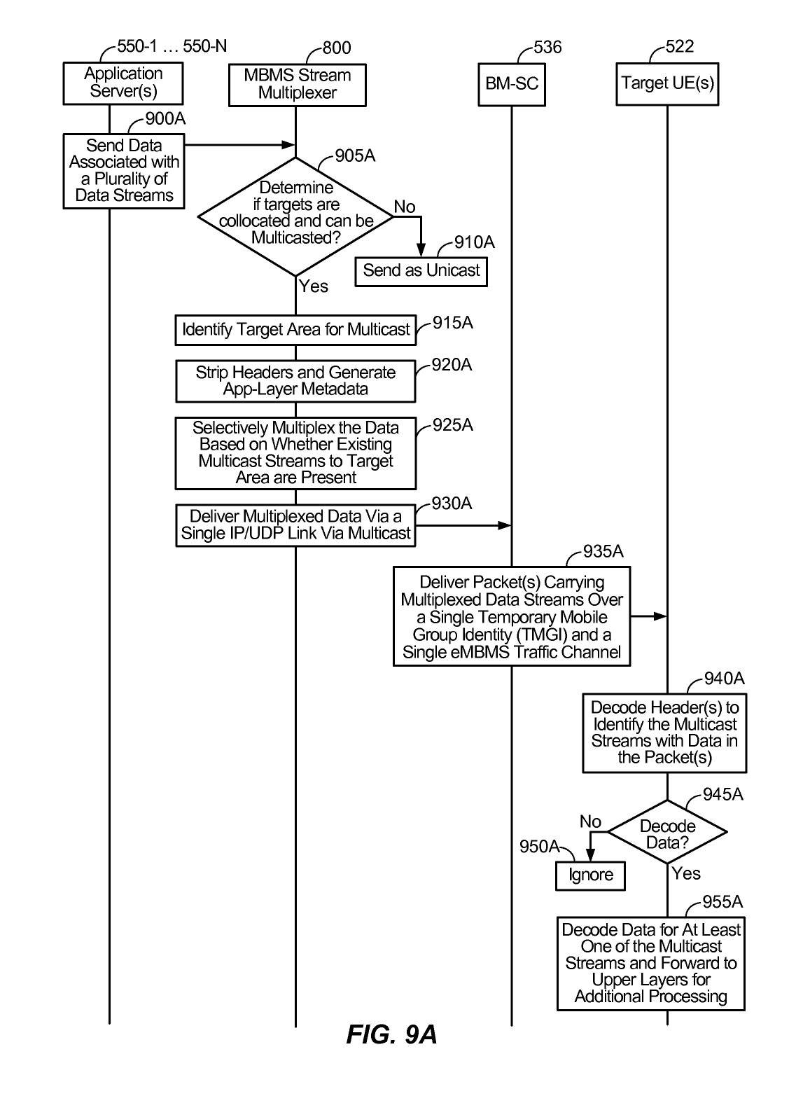

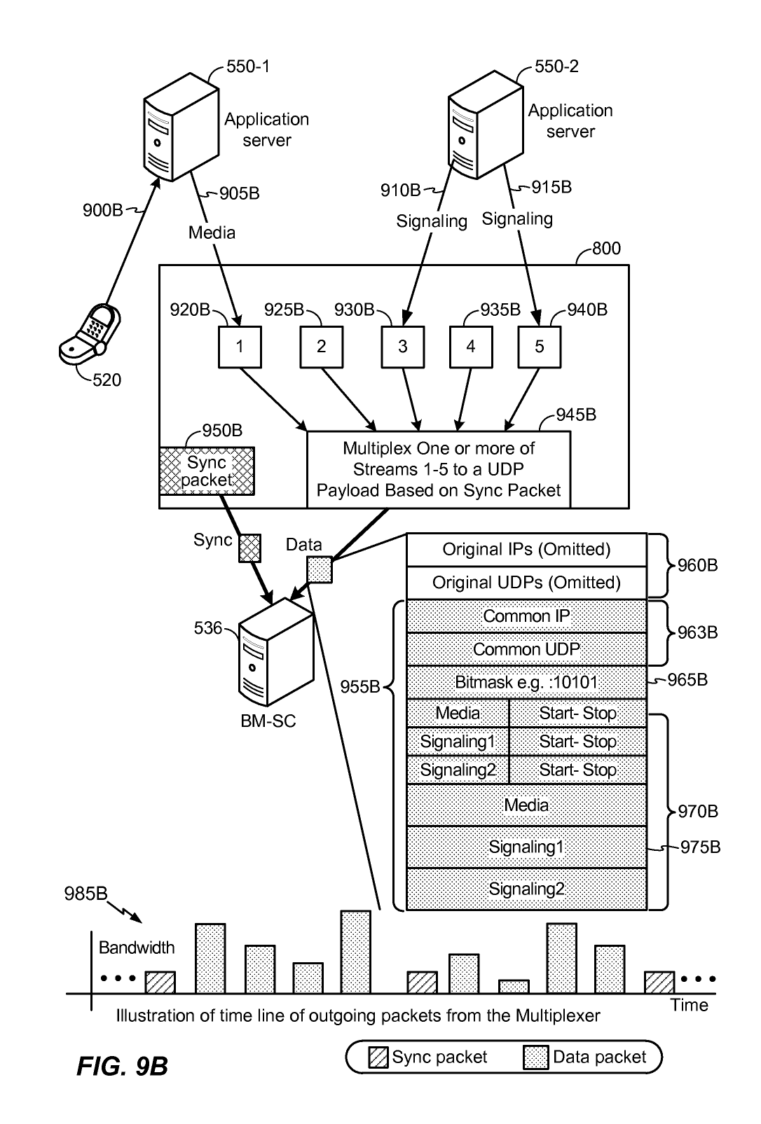

In FIG. 5B, the application server 550 is shown as having a direct connection to the BM-SC 536, implying that each application server 550 has its own IP/UDP connection to the BM-SC 536. In FIG. 8, the application servers 550-1 . . . 550-N have the direct connection to the BM-SC 536 as in FIG. 5B but the application servers 550-1 . . . 550-N are also connected to an MBMS stream multiplexer 800. The MBMS stream multiplexer 800 can be implemented as a remote or independent server or as a part of the application server 550. As will be described below in more detail with respect to FIGS. 9A-9B, the MBMS stream multiplexer 800 is configured to selectively multiplex multiple E-MBMS streams (or flows) from a single application server or different application servers onto a single IP/UDP link for delivery to the BM-SC 536. This permits multiple E-MBMS streams to share a common temporary mobile group identity (TMGI), a common IP/UDP link and thereby, at the individual eNode Bs, a common physical channel resource (i.e., a common sub frame). As will be described in greater detail below, multicast data deemed by the application server(s) to warrant multiplexing can be routed to the stream multiplexer 800, which multiplexes the incoming data and then forwards multiplexed data to the target BM-SC 536 or PDSN/PGW 536′. On the other hand, multicast data deemed by the application server(s) not to warrant multiplexing (at least, within one or more target areas for transmission) can be forwarded directly to the target BM-SC 536 or PDSN/PGW 536′.

FIGS. 9A and 9B illustrate an example of multiplexing data associated with different data streams onto a single multicast stream in accordance with an embodiment of the present invention.

Referring to FIG. 9A, the application servers 550-1 . . . 550-N provide data associated with a plurality of different data streams to the stream multiplexer 800, 900A. For example, the plurality of different data streams provided at 900A can be associated with a single E-MBMS service (e.g., media and control parts), different E-MBMS services, unicast services, etc. FIG. 9B illustrates an example of how 900A of FIG. 9A can be implemented, whereby an originating UE 520 provides unicast media to the application server 550-1 for transmission to a multicast group as an E-MBMS stream, 900B, and the application server 550-1 then forwards the unicast media to the stream multiplexer 800, 905B. Also, signaling information associated with the E-MBMS stream can be sent by the application server 550-2, 910B and 915B.

After receiving the data associated with the plurality of data streams, the stream multiplexer 800 determines whether to transmit the respective streams to the target UE(s) via multicast or unicast, 905A. This determination is based on whether the target UE(s) are collocated and are able to receive multicast traffic. If the stream multiplexer 800 determines to transmit via IP unicast in 905A, the incoming data is multiplexed and then transmitted to the target UE(s) via unicast, 910A. Alternatively, if the stream multiplexer 800 determines to transmit via IP multicast in 905A, the stream multiplexer 800 identifies a target area for the multicasting of the respective data streams, 915A. For example, at 915A, the stream multiplexer 800 may determine to direct a first data stream to MBSFN 1, to direct a second data stream to MBSFN 1, to direct a third data stream to MBSFN 2, and so on.

Referring to FIG. 9A, it will be appreciated that the data packets for each respective data stream that arrives at 900A are associated with their own stream-specific IP and UDP addresses. In the embodiment of FIG. 9A, instead of simply forwarding these data packets to the BM-SC 536 separately with their stream-specific IP and UDP addresses intact, the IP and UDP headers for data packets of separate data streams that are targeted to the same MBSFN area are stripped or removed at 920A. Then, in 925A, the payload portions of the stripped data packets are merged into a single data packet with a common IP/UDP address. Further, in 925A, if there are existing multicast streams already being delivered to same target MBSFN area as the stripped data packets, the stripped data packets can further be merged with these existing multicast streams as well. As will be appreciated, merging the payloads of the data packets from multiple multicast streams reduces the overhead associated with sending each of these data streams with separate headers having their own IP/UDP addresses.

The multiplexing procedure of 925A is shown in more detail within FIG. 9B. Referring to FIG. 9B, the media and signaling streams 905B through 915B arrive at the stream multiplexer 800 and, along with other incoming data streams (not shown), are added to stream buffers 920B through 940B. The stream multiplexer 800 selectively merges the data payloads from these buffered packets into packets with common IP/UDP addresses for delivery to the BM-MS 536, 945B. In the embodiment of FIG. 9B, with the assumption that the media stream 905B and the signaling streams 910B and 915B are targeted to the same target MBSFN area, these media streams are multiplexed at 945B. This selective multiplexing can be conveyed to target UEs via a sync packet 950B, in an example, which can be generated by logic at the stream multiplexer 800 responsible for identifying and comparing the respective target MBSFN areas for the incoming data streams. As will be described in more detail below, the sync packet 950B can be sent to target UEs of the associated multiplexed data streams in an event-driven manner (e.g., each time the multiplexing format changes, such as when a data stream is added or removed, the data streams are re-arranged, the bitmask mapping changes, etc.) and/or periodically.

In FIG. 9B, 955B illustrates an example of the payload portion for a particular multicast stream within the merged or multiplexed packet. As shown in FIG. 9B, the original IP/UDP addresses 960B from the incoming data packet at the stream multiplexer 800 are removed and replaced with common IP/UDP addresses 963B for all of the respective data payloads contained therein. The multiplexed packet 955B further includes a bitmask 965B that instructs a target UE with respect to the sources of the respective payload portions of the multiplexed IP/UDP packet 955B. For example, the bitmask 965B indicates that the payload portion 970B is associated with multicast stream 1, that the payload portion 975B is associated with multicast stream 2 and 3, and so on.

Returning to FIG. 9A, after selectively multiplexing the data streams in 925A, the stream multiplexer 800 delivers the multiplexed data packet(s) to the BM-SC 536, 930A. The BM-SC 536 in turn delivers the multiplexed data packet(s) to their respective target MBSFN areas, 935A. At least one target UE 522 within the target MBSFN area(s) receives and decodes the header of the multiplexed data packet, 940A. Based on the header decoding from 940A, the target UE determines whether it is a target for one or more of the payload portions contained therein, 945A. For example, the target UE can evaluate the bitmask 965B from the header of the multiplexed data packet to identify the service(s) associated with the respective payload portions, and then determine whether the UE is interested in the associated service(s). As discussed above, the sync packets 950B provide the mapping of bits in the Bitmask to the stream identifying information. Moreover when a new stream is multiplexed or removed from multiplexing, the sync packet 950B is sent to update the mapping. For example, when data for a particular stream is included, a corresponding bit-position of the bitmask 965B is set to 1. Thus, bit position #1 in 965B is set to 1 to indicate that media stream 920B has data in the multiplexed packet, bit position #2 in 965B is set to 0 to indicate that stream 925B does not have data in the multiplexed packet, and so on. In FIG. 9B, timeline 985B shows the transmission of the sync packets 950B along with the transmission of multiplexed packets (with varying payload levels based in part upon the number of streams being multiplexed in a particular packet). Referring to FIG. 9A, if the target UE determines that it is not interested in any of the payloads contained in the multiplexed data packet in 945A, the target UE ignores the multiplexed data packet and does not decode it further, 950A. Otherwise, if the target UE determines that it is interested in at least one of the payloads contained in the multiplexed data packet in 945A, the target UE decodes the relevant payload portions and forwards the decoded payload portions to upper layers of the target UE for further processing, 955A.

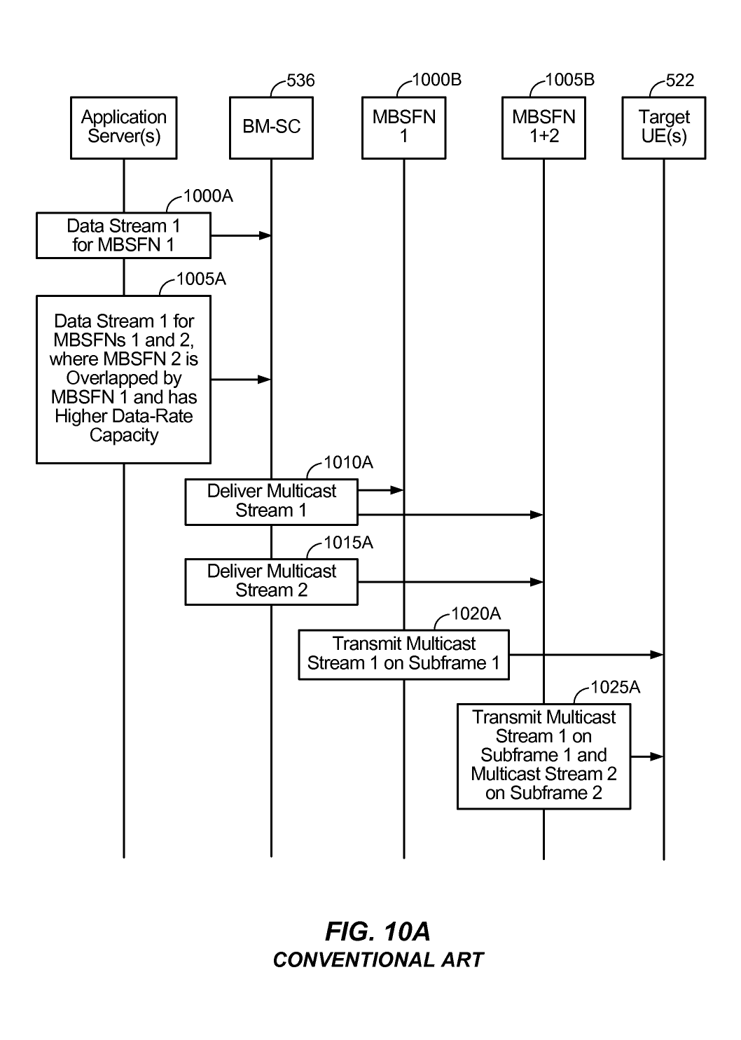

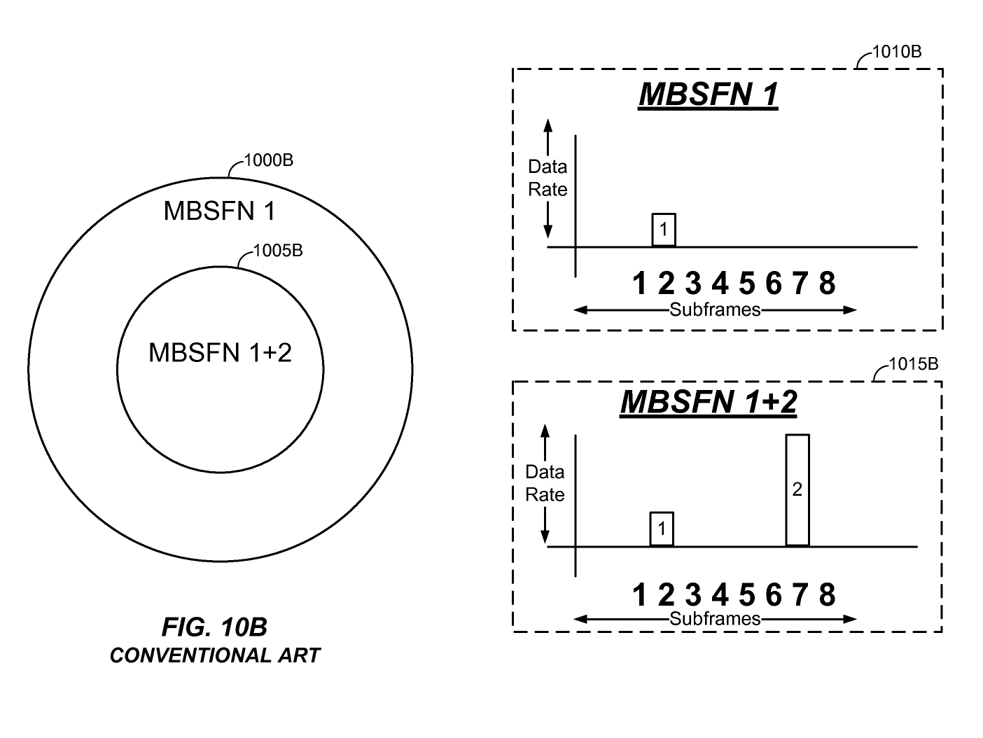

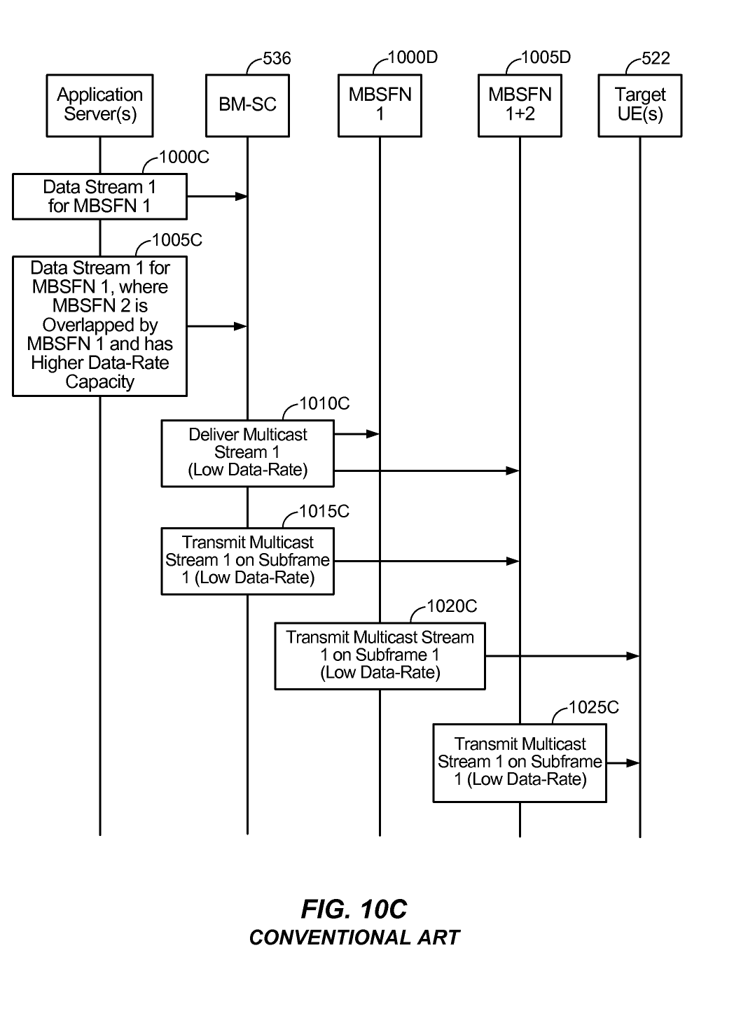

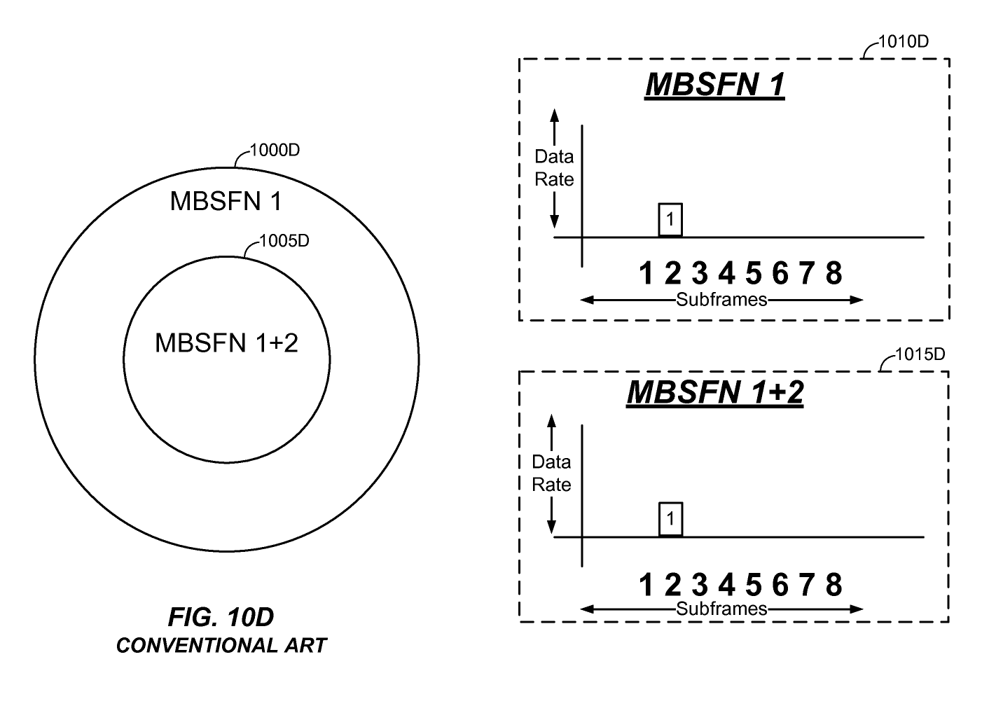

In a wireless broadcast or a multicast system using a single frequency transmission like E-MBMS in LTE or BCMCS in CDMA 2000, effective data rates can be improved via soft combining signals from multiple base stations. To leverage soft combining gains, the base stations in the broadcast/multicast area (e.g., the MBSFN area in E-MBMS) must transmit the same signal in time and frequency domain for the respective channel. Soft combining present two challenges for capacity:
Firstly, when two different MBSFN areas overlap (i.e., areas with different broadcast/multicast data streams), then two separate sub frames need to be used to ensure soft combining gains and the target data rates. This leads to an increase in usage of OTA resources thereby reducing capacity. In a wireless broadcast/multicast service like E-MBMS, the target data rate selected for transmission is determined based on the network topology. Each network topologies requires appropriate cell radius (e.g., for a dense urban network) requires a small cell radius and more base station as compared to a Suburban or a rural topology. The data rate is directly proportional to the cell radius and is dependent on other RF propagation specific parameters. This aspect is explained in more detail below with respect to FIGS. 10A-10B.
Secondly, when a single area MBSFN area (area to be serviced by the same content) covers a large geographic area covering multiple network topology classes, the maximum data rate supported is limited by the lowest common data rate; which relates to the topology supporting the least data rate. For example, if a MBSFN area consists of a dense urban morphology, the MBSFN area may support 20 Mbps, whereas a suburban area may support 1 Mbps for a similar sub frame allocation. The data rate offered in this region would be limited to 1 Mbps. Thus the conventional approach would waste capacity in areas that would potentially offer higher bandwidth, such as the dense urban portion of the MBSFN area. This aspect is explained in more detail below with respect to FIGS. 10C-10D.

FIGS. 10A through 10D illustrate conventional multicast stream delivery procedures. In particular, FIGS. 10A through 10D illustrate processes of delivering multicast streams without multiplexing streams together within common UDP/IP packets as discussed above with respect to FIGS. 8-9B. Accordingly, FIGS. 10A through 10D are described without reference to the MBMS stream multiplexer 800, which is responsible for the above-noted stream multiplexing.

Referring to FIG. 10A, one or more application servers deliver first and second data streams to the BM-SC 536, 1000A and 1005A, whereby the first data stream is targeted to a first MBSFN area (“MBSFN 1”) and the second data stream is targeted to a second MBSFN area (“MBSFN 2”) that is overlapped by MBSFN 1. In FIG. 10A, assume that the first and second data streams are associated with different E-MBMS services and arrive from different application servers. With reference to FIG. 10B, MBSFN 1 is shown as 1000B and MBSFN 2 is shown as 1005B. Because MBSFN 1 extends into the area covered by MBSFN 2, the overlapping region between MBSFN 1 and MBSFN 2 is designated as MBSFN 1+2, such that references to MBSFN 1 below with respect to FIGS. 10A and 10B correspond to the portions of MBSFN that do not overlap with MBSFN 2.

Referring to FIG. 10A, the BM-SC 536 delivers the first data stream as a first multicast stream to MBSFN 1, 1010A, and to MBSFN 1+2, 1015A. MBSFN 1 transmits the first multicast stream on a first sub frame, 1020A, and MBSFN 1+2 transmits both the first multicast stream on the first sub frame and also the second multicast stream on a second sub frame, 1025A.

FIG. 10B illustrates the transmission frame allocation for 1020A and 1025A within MBSFN 1 and MBSFN 1+2, respectively. As shown in 1010B, within MBSFN 1, sub frame 2 is allocated to the first multicast stream. Also, as shown in 1015B, within MBSFN 1+2, sub frame 2 is allocated to the first multicast stream and sub-frame 7 is allocated to the second multicast stream. The second multicast stream is shown as having a higher data rate than the first multicast stream as an example whereby MBSFN 2 corresponds to a serving area with high data rates (e.g., in proximity to a city with a dense Node B concentration) and MBSFN 1 corresponds to a serving area that includes the high data rate serving area and also includes a lower data rate serving area (e.g., a rural area with a sparse Node B concentration).

As will be appreciated from a review of FIGS. 10A-10B, the first data stream is transmitted with a relatively low data rate in the non-overlapping portions of MBSFN 1 due to capacity restrictions, and the first data stream is transmitted with the same low data rate in MBSFN 1+2 to support soft combining. Also, throughout the entire overlapping region of MBSFN 2, two separate sub frames are required for transmission of the first and second multicast streams.

Referring to FIG. 10C, an application servers delivers a first data stream to the BM-SC 536, 1000C, whereby the first data stream is targeted to MBSFN 1. Further assume that MBSFN 2, which is a portion or subset of MBSFN 1, has a higher data rate capacity as compared to the portions of MBSFN 1 that do not overlap with MBSFN 2. Accordingly, because the first data stream is to be transmitted throughout the entirety of MBSFN 1, the first data stream is allocated a relatively low data rate (at least, lower than the available capacity within MBSFN 2). With reference to FIG. 10D, MBSFN 1 is shown as 1000D and MBSFN 1+2 (i.e., the portion of MBSFN 1 that overlaps with MBSFN 2) is shown as 1005D. Because MBSFN 1 extends into the area covered by MBSFN 2, the overlapping region between MBSFN 1 and MBSFN 2 is designated as MBSFN 1+2, such that references to MBSFN 1 below with respect to FIGS. 10C and 10D correspond to the portions of MBSFN that do not overlap with MBSFN 2.

Referring to FIG. 10C, the BM-SC 536 delivers the first data stream as a multicast stream to MBSFN 1 and MBSFN 1+2, and the BM-SC 536 also delivers the second data stream as a second multicast stream to MBSFN 2, 1005C. Both MBSFN 1 and MBSFN 1+2 transmit the multicast stream with the relatively low data rate, 1010C and 1015C. For example, MBSFN 1+2 does not simply use a higher data rate in place of the lower data rate used in MBSFN 1 because soft combining between the disparate data rate transmissions would not be possible.

FIG. 10D illustrates the transmission frame allocation for 1010C and 1015C within MBSFN 1 and MBSFN 1+2, respectively. As shown in 1010D, within the portions of MBSFN 1 that do not overlap with MBSFN 2, sub frame 2 is allocated to the multicast stream. As shown in 1015D, within MBSFN 1+2, sub frame 2 is also allocated to the multicast stream.

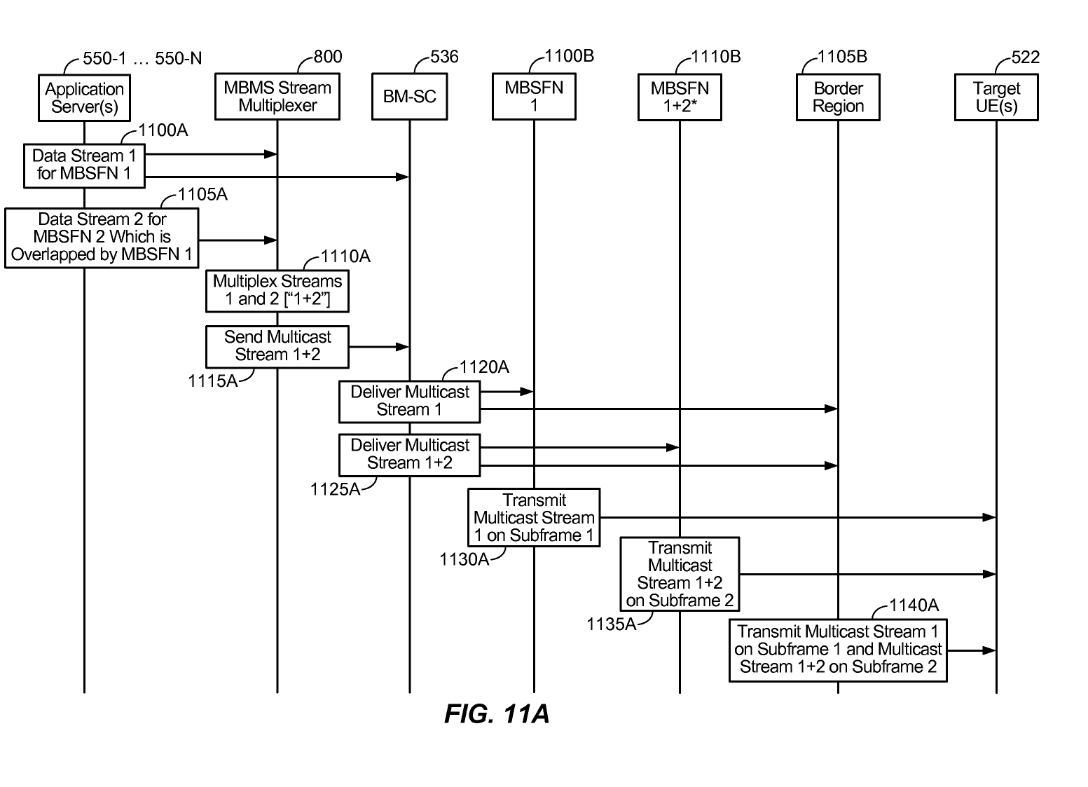

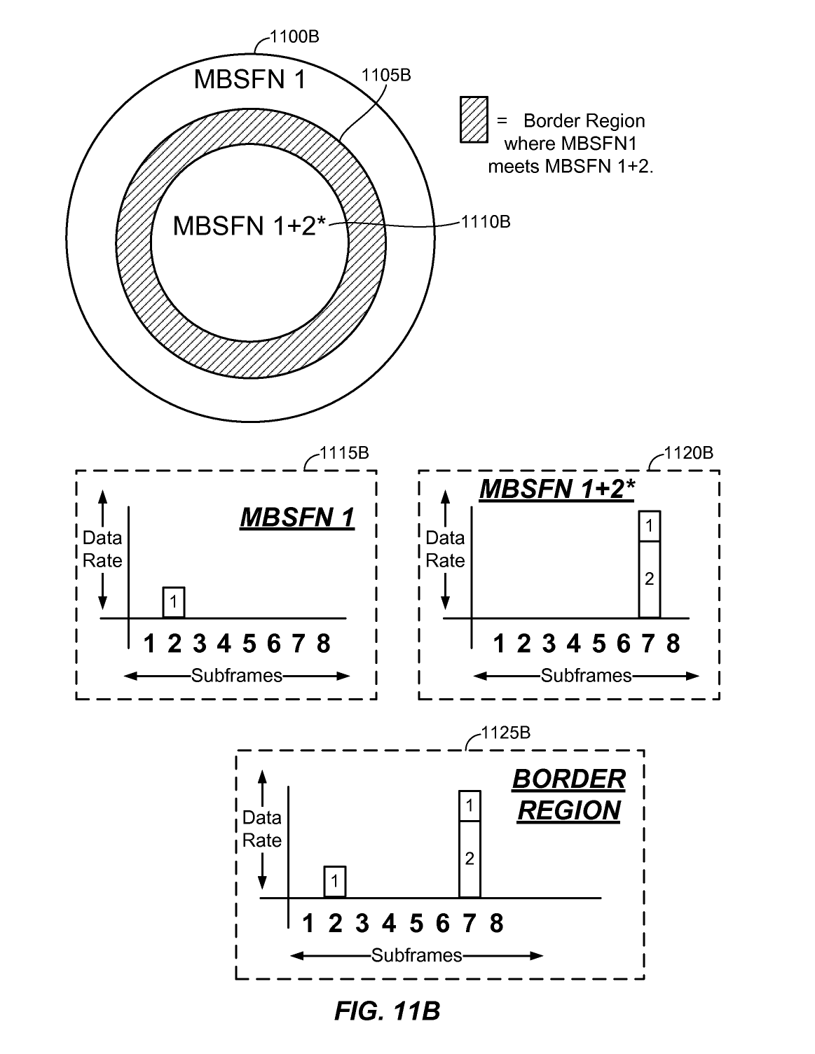

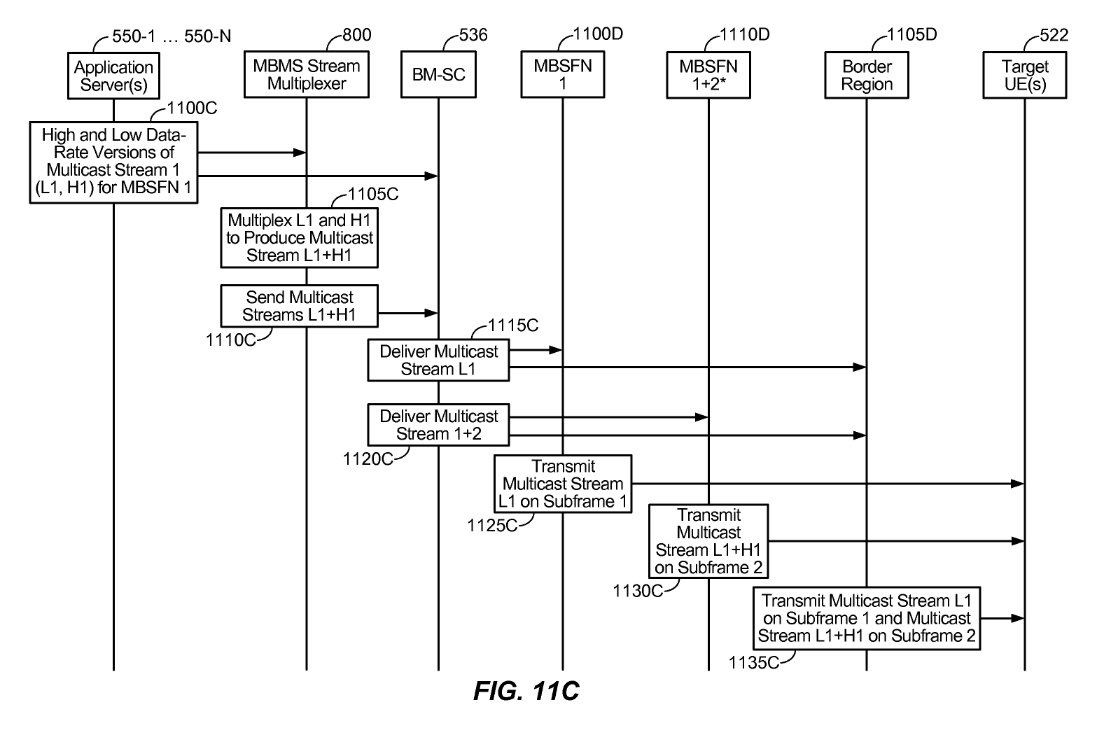

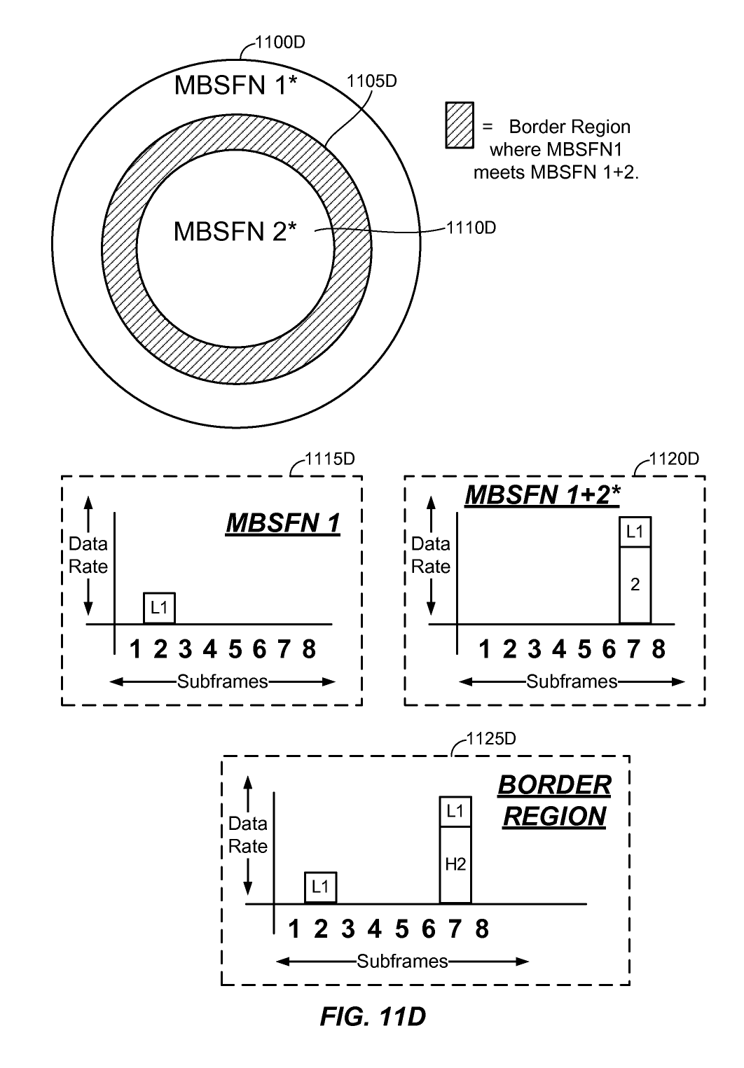

Accordingly, FIGS. 10A and 10B show that, conventionally, two separate sub frames are required to transmit two distinct E-MBMS streams in a high-capacity MBSFN, and FIGS. 10C and 10D show how supporting a single E-MBMS service across a serving area with low capacity and high capacity areas can fail to leverage the higher capacity in the high capacity areas. Embodiments of the invention described below with respect to FIGS. 11A through 11D are directed to implementations whereby multicast stream multiplexing is used to achieve, in certain instances, single sub frame allocations for multiple E-MBMS services and also to achieve disparate data rate support for a single E-MBMS service across a serving area with different capacity support levels.

Referring to FIG. 11A, one or more of application servers 550-1 through 550-N deliver first and second data streams to the MBMS stream multiplexer 800, 1100A and 1105A, whereby the first data stream is targeted to a first MBSFN area (“MBSFN 1”) and the second data stream is targeted to a second MBSFN area (“MBSFN 2”) that is overlapped by MBSFN 1. The delivery of the first and second data streams to the MBMS stream multiplexer 800 is based on the assessment that the respective data streams are targeted to the same target area or overlapping target areas, such that multiplexing of the respective streams is warranted. Also in 1100A, the first data stream is also conveyed by the application servers 550-1 . . . 550-N directly to the BM-SC 536 because the first data stream will also be transmitted in a portion of the target MBSFN(s) in a non-multiplexed manner (e.g., the portion of MBSFN 1 that is exclusive of MBSFN 1+2 and/or the border region between MBSFN 1 and MBSFN 1+2, discussed below in more detail). In FIG. 11A, assume that the first and second data streams are associated with different E-MBMS services and arrive from different application servers. The difference in the streams may be based on different data rates, QoS, priority, and/or other environmental conditions. With reference to FIG. 11B, MBSFN 1 is shown as 1100B. Also shown in FIG. 11B is a border region 1105B within MBSFN 1+2 in proximity to MBSFN 1, and a region denoted as MBSFN 1+2* which corresponds to MBSFN 1+2 without the border region 1105B. Accordingly, the border region 1105B includes a set of outlying sectors among MBSFN 2 in proximity to sectors in MBSFN 1 that are not part of MBSFN 1+2*. The aggregate of MBSFN 1+2* and the border region 1105B corresponds to the entirety of MBSFN 1+2.

Referring to FIG. 11A, the MBMS stream multiplexer 800 determines that the first and second data streams are targeted to the same target region (i.e., MBSFN 1+2, or the combination of MBSFN 1+2* plus the border region 1105B), and that the first data stream is also targeted to the remainder of MBSFN 1. Accordingly, the MBMS stream multiplexer 800 multiplexes the first and second data streams to produce a multiplexed multicast stream 1+2 (e.g., as discussed above with respect to FIGS. 8 through 9B), 1110A. The MBMS stream multiplexer 800 delivers the multiplexed multicast stream 1+2, 1115A. The BM-SC 536 in turn delivers the first multicast stream to MBSFN 1 and the border region 1105B, 1120A, and the BM-SC 536 delivers the multicast stream 1+2 to MBSFN 1+2* and the border region 1105B, 1125A.

MBSFN 1 transmits the first multicast stream on a first sub frame, 1130A, MBSFN 1+2* transmits the multicast stream 1+2 on a second sub frame, 1135A, and the border region 1105B transmits both the first multicast stream on the first sub frame and the multicast stream 1+2 on the second sub frame, 1140A.

FIG. 11B illustrates the transmission frame allocation for 1130A through 1145A within MBSFN 1, MBSFN 1+2* and the border region 1105B, respectively. As shown in 1115B, within MBSFN 1, sub frame 2 is allocated to the first multicast stream. Also, as shown in 1120B, within MBSFN 1+2*, sub frame 7 is allocated to the multicast stream 1+2. Also, as shown in 1125B, within the border region 1105B, sub frame 2 is allocated to the first multicast stream and sub frame 7 is allocated to the multicast stream 1+2.

Referring to FIG. 11B, it will be appreciated from a review of 1115B through 1120B that in contrast to FIG. 10B, the entirety of MBSFN 1+2 does not need to use two separate sub-frames for carrying the data for multicast streams 1 and 2. Instead, a common IP stream with payloads from both multicast streams is carried in MBSFN 1+2*, with only the border region 1105B being required to carry the respective streams on two sub frames for purposes of soft combining Again, this becomes possible in part due to the higher capacity associated with MBSFN 1+2 as compared to the rest of MBSFN 1 in combination with the multicast stream or payload multiplexing discussed above with respect to FIGS. 8 through 9B.

Referring to FIG. 11C, one or more of application servers 550-1 through 550-N deliver first and second data streams to the MBMS stream multiplexer 800, 1100C, whereby the first data stream is a low data rate stream (“L1”) and the second data rate stream is a high data rate stream (“H1”). The first and second data streams at 1100C are associated with the same E-MBMS service. The delivery of the high and low rate data streams to the MBMS stream multiplexer 800 is based on the assessment that the respective data streams are targeted to the same target area or overlapping target areas, such that multiplexing of the respective streams is warranted. Also in 1100C, the low rate data stream L1 is also conveyed by the application servers 550-1 . . . 550-N directly to the BM-SC 536 because the low rate data stream L1 will also be transmitted in a portion of the target MBSFN(s) in a non-multiplexed manner (e.g., the portion of MBSFN 1 that is exclusive of MBSFN 1+2 and/or the border region between MBSFN 1 and MBSFN 1+2, discussed below in more detail). The first and second data streams are both targeted to MBSFN 1, which includes or encapsulates MBSFN 2. As discussed above, the MBSFN 2 is a higher capacity portion of MBSFN 1, such that higher data rates are achievable within MBSFN 2 (or MBSFN 1+2) as compared to other portions of MBSFN 1. With reference to FIG. 11D, MBSFN 1 is shown as 1100D. Also shown in FIG. 11D is a border region 1105D within MBSFN 1+2 in proximity to MBSFN 1, and a region denoted as MBSFN 1+2* which corresponds to MBSFN 1+2 without the border region 1105D. Accordingly, the border region 1105D includes a set of outlying sectors among MBSFN 1+2 in proximity to sectors in MBSFN 1 that are not part of MBSFN 1+2*. The aggregate of MBSFN 1+2* and the border region 1105D corresponds to the entirety of MBSFN 1+2.

Referring to FIG. 11C, the MBMS stream multiplexer 800 determines that the data streams L1 and H1 are targeted to the same target region (i.e., MBSFN 1+2, or the combination of MBSFN 1+2* plus the border region 1105D), and that the data stream L1 is also targeted to remainder of MBSFN 1. These target MBSFNs for the data streams L1 and H1 are determined based on the capacity levels of the target MBSFNs, in an example. Accordingly, the MBMS stream multiplexer 800 multiplexes the data streams L1 and H1 to produce a multiplexed multicast stream L1+H1 (e.g., as discussed above with respect to FIGS. 8 through 9B), 1105C. The MBMS stream multiplexer 800 delivers the multiplexed multicast stream L1, 1110C. The BM-SC 536 in turn delivers the first data stream L1 as a first multicast stream L1 to MBSFN 1 and the border region 1105D, 1115C, and the BM-SC 536 delivers the multicast stream L1+H1 to MBSFN 1+2* and the border region 1105B, 1120C.

MBSFN 1 transmits the multicast stream L1 on a first sub frame, 1125C, MBSFN 1+2* transmits the multicast stream L1+H1 on a second sub frame, 1130C, and the border region 1105B transmits both the multicast stream L1 on the first sub frame and the multicast stream L1+H1 on the second sub frame, 1135C.

FIG. 11D illustrates the transmission frame allocation for 1125C through 1135C within MBSFN 1, MBSFN 1+2* and the border region 1105D, respectively. As shown in 1115D, within MBSFN 1, sub frame 2 is allocated to the multicast stream L1. Also, as shown in 1120D, within MBSFN 1+2*, sub frame 7 is allocated to the multicast stream L1+H1. Also, as shown in 1125D, within the border region 1105D, sub frame 2 is allocated to the multicast stream L1 and sub frame 7 is allocated to the multicast stream L1+H1.

Referring to FIG. 11D, it will be appreciated from a review of 1115D through 1125D that in contrast to FIG. 10D, the multiplexing of the multicast streams L1 and H1 permits the higher data rate multicast stream H1 to be carried within MBSFN 1+2 while still supporting soft combining of multicast stream L1 by also carrying the multicast stream L1 within the border region 1105D. Again, this becomes possible in part due to the higher capacity associated with MBSFN 1+2 as compared to the rest of MBSFN 1 in combination with the multicast stream or payload multiplexing discussed above with respect to FIGS. 8 through 9B.

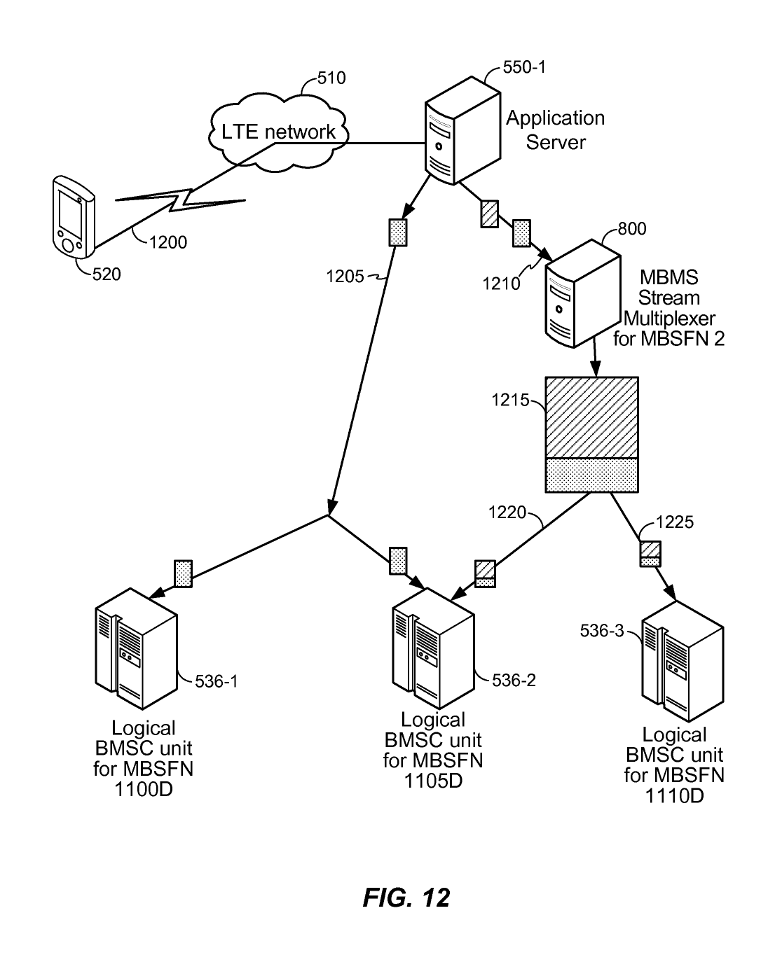

FIG. 12 illustrates a process of generating and disseminating multiplexed and non-multiplexed data packets in accordance with another embodiment of the invention. In particular, FIG. 12 shows how the multiplexed and non-multiplexed transmitted within MBSFN 1, 1+2* and the border region 1105D in FIGS. 11C through 11D move through various network elements.

Referring to FIG. 12, an originating UE 520 transmits a unicast packet for transmission to a multicast or MBMS group to the LTE network 510, and the LTE network 510 forwards the unicast packet to the application server 550-1, 1200. The application server 550-1 determines that a low data rate version of the payload of the unicast packet can be sent in MBSFN 1 or MBSFN 1100D, and that a high data rate version of the payload of the unicast packet can be sent in the border region 1105D and also within MBSFN 1110D. Accordingly, the application server 550-1 sends the low data rate version of the payload of the unicast packet directly to target BM-CSs 536-1 and BM-SC 536-2 within MBSFNS 1100D and 1105D, respectively, for transmission, 1205, and the application server 550-1 sends both the low and high data rate version of the payload of the unicast packet to the MBMS stream multiplexer 800 for multiplexing, 1210. 1205 and 1210 of FIG. 12 thereby represent example implementations of 1100C and 1115C of FIG. 11C, in an example.

Referring to FIG. 12, the MBMS stream multiplexer 800 multiplexes the low and high rate data streams to produce a multiplexed data packet 1215, which is forwarded to BM-SCs 536-2 and 536-3 for the target MBSFNs 1105D and 1110D, respectively, 1220 and 1225, 1220 and 1225 of FIG. 12 thereby represent example implementations of 1110C of FIG. 11C, in an example. Thus, FIG. 12 shows how the respective BM-SCs can each be provisioned with the appropriate multicast streams for transmission, resulting in the transmission frame allocations shown in 1115D through 1125D of FIG. 11D. It will be appreciated that FIG. 12 could be modified slightly to show the dissemination of multiplexed and non-multiplexed data for FIGS. 11A-11B by modifying the single unicast packet being multicast as in FIG. 12 for multicasting of data from multiple sources as in FIGS. 11A-11B.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for group communications over evolved multimedia broadcast/multicast services (E-MBMS). Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating an application server that is distributing a plurality of multicast streams to a plurality of target user equipments (UEs) in a communications system, comprising:
determining a first multicasting area for transmission of a first multicast stream having a first data rate, a second multicasting area for transmission of a second multicast stream having a second data rate that is different than the first data rate, and a third multicasting area that overlaps with the second multicasting area for transmission of both the first and second multicast streams;
obtaining a first set of data packets that are associated with the first multicast stream;
obtaining a second set of data packets that are associated with the second multicast stream;
delivering, for transmission within the first and third multicasting areas, the first set of data packets to a multicast network management node configured to manage Internet Protocol (IP) multicast transmissions; and
delivering, to a multiplex stream multiplexer, the first and second sets of packets to be multiplexed into a single multiplexed multicast stream for transmission within the second and third multicasting areas, wherein the single multiplexed multicast stream has a third data rate that is higher than the first and/or second data rates.

2. The method of claim 1, wherein the third multicasting area corresponds to a border region between the first and second multicasting areas that overlaps with the second multicasting area.

3. The method of claim 2,
wherein the single multiplexed multicast stream is provided in the second and third multicasting areas at the third data rate to permit soft combining of the single multiplexed multicast stream by target UEs in proximity to the third multicasting area, and
wherein the first multicast stream is provided in the first and third multicasting areas at the first data rate to permit soft combining of the single multiplexed multicast stream by target UEs in proximity to the third multicasting area, and

4. The method of claim 1,
wherein the second and third multicasting areas correspond to a higher data-rate multicasting area,
wherein the first multicasting area corresponds to a lower data-rate multicasting area.

5. The method of claim 1, wherein the first multicast stream occupies a smaller portion of the single multiplexed multicast stream as compared to the second multicast stream in terms of data rate.

6. The method of claim 1, wherein the first and second multicast streams correspond to low data-rate and high-data rate versions, respectively, of a common multicast communication service.

7. The method of claim 6, wherein the common multicast service is an evolved multimedia broadcast/multicast services (E-MBMS) service being carried in the first, second and third multicasting areas.

8. The method of claim 1, wherein the first and second multicast streams correspond to different multicast communication services.

9. The method of claim 8, wherein the first and second multicast services are evolved multimedia broadcast/multicast services (E-MBMS) services.

10. The method of claim 1, wherein the multicast network management node corresponds to a broadcast multicast service center (BM-SC).

11. The method of claim 1, wherein the first data rate is lower than the second data rate.

12. A method of operating a network device that is configured to multiplex a set of streams into a single output stream for delivery to a plurality of target devices, comprising:
receiving a first data packet associated with a first multicast stream for transmission in a given multicasting area and having a first data rate;
receiving a second data packet associated with a second multicast stream for transmission in the given multicasting area and having a second data rate that is different from the first data rate;
multiplexing the first and second data packets into a multiplexed data packet for a multiplexed multicast stream having a third data rate that is higher than the first and/or second data rates, wherein the multiplexed data packet includes (i) a first payload portion from the first data packet based on the first data rate, and (ii) a second payload portion from the second data packet based on the second data rate; and
delivering, for transmission within the given multicasting area, the multiplexed data packet to a multicast network management node configured to manage IP multicast transmissions within the given multicasting area.

13. The method of claim 12, wherein the first data rate is lower than the second data rate.

14. The method of claim 13, wherein the given multicasting area includes a first multicasting area where the first multicast stream is being carried at the first data rate independent of the multiplexed multicast stream, and a second multicasting area where the first multicast stream is not being carried at the first data rate independent of the multiplexed multicast stream.

15. The method of claim 13, wherein the first payload portion occupies a smaller portion of the multiplexed data packet than the second payload portion in terms of data rate.

16. The method of claim 12, wherein the second data rate is lower than the first data rate.

17. The method of claim 16, wherein the given multicasting area includes a first multicasting area where the second multicast stream is being carried at the second data rate independent of the multiplexed multicast stream, and a second multicasting area where the second multicast stream is not being carried at the second data rate independent of the multiplexed multicast stream.

18. The method of claim 16, wherein the second payload portion occupies a smaller portion of the multiplexed data packet than the first payload portion in terms of data rate.

19. The method of claim 12, wherein the first and second multicast streams correspond to high data-rate and low-data rate versions of a common multicast communication service.

20. The method of claim 19, wherein the common multicast service is an evolved multimedia broadcast/multicast services (E-MBMS) service being carried in the given multicasting area.

21. The method of claim 12, wherein the first and second multicast streams correspond to different multicast communication services.

22. The method of claim 21, wherein the first and second multicast services are evolved multimedia broadcast/multicast services (E-MBMS) services being carried in the given multicasting area.

23. The method of claim 12, wherein the given multicast network management node corresponds to a broadcast multicast service center (BM-SC).

24. The method of claim 12, wherein the multiplexed data packet is configured for transmission by the multicast network management node on a single sub-frame of an evolved multimedia broadcast/multicast services (E-MBMS) traffic channel.

25. A method of operating a target user equipment (UE) that is configured to monitor one or more multicast streams, comprising:
receiving, on a downlink multicast channel, a multiplexed data packet that includes (i) a first payload portion associated with a first multicast stream and having a first data rate, and (ii) a second payload portion associated with a second multicast stream and having a second data rate that is different from the first data rate;
determining whether the first and/or the second multicast streams are relevant to the target UE; and
selectively decoding and processing the first and second payload portions based on the determination.

26. The method of claim 25,
wherein the determining determines that the first multicast stream is relevant to the target UE and the second multicast stream is not relevant to the target UE, and
wherein the selectively decoding and processing includes:
decoding and processing the first payload portion and not the second payload portion.

27. The method of claim 25,
wherein the determining determines that the second multicast stream is relevant to the target UE and the first multicast stream is not relevant to the target UE, and
wherein the selectively decoding and processing includes:
decoding and processing the second payload portion and not the first payload portion.

28. The method of claim 25,
wherein the determining determines that both the first and second multicast streams are relevant to the target UE, and
wherein the selectively decoding and processing includes:
decoding and processing both the first and second payload portions.

29. The method of claim 25,
wherein the determining determines that neither the first and second multicast streams are relevant to the target UE, and
wherein the selectively decoding and processing includes:
refraining from decoding and processing the first and second payload portions.

30. The method of claim 25,
wherein the downlink multicast channel corresponds to an evolved multimedia broadcast/multicast services (E-MBMS) traffic channel, and
wherein the multiplexed data packet is receiver on a single sub-frame of the MTCH.

31. The method of claim 25, wherein the first data rate is lower than the second data rate.

32. The method of claim 31, wherein the first payload portion occupies a smaller portion of the multiplexed data packet than the second payload portion in terms of data rate.

33. The method of claim 25, wherein the second data rate is lower than the first data rate.

34. The method of claim 33, wherein the second payload portion occupies a smaller portion of the multiplexed data packet than the first payload portion in terms of data rate.

35. The method of claim 25, wherein the first and second multicast streams correspond to high data-rate and low-data rate versions of a common multicast communication service.

36. The method of claim 35, wherein the common multicast service is an evolved multimedia broadcast/multicast services (E-MBMS) service being carried in a given multicasting area.

37. The method of claim 25, wherein the first and second multicast streams correspond to different multicast communication services.

38. The method of claim 25, wherein the first and second multicast services are evolved multimedia broadcast/multicast services (E-MBMS) services being carried in a given multicasting area.

39. An application server configured to distribute a plurality of multicast streams to a plurality of target user equipments (UEs) in a communications system, comprising:
means for determining a first multicasting area for transmission of a first multicast stream having a first data rate, a second multicasting area for transmission of a second multicast stream having a second data rate that is different than the first data rate, and a third multicasting area that overlaps with the second multicasting area for transmission of both the first and second multicast streams;
means for obtaining a first set of data packets that are associated with the first multicast stream;
means for obtaining a second set of data packets that are associated with the second multicast stream;
means for delivering, for transmission within the first and third multicasting areas, the first set of data packets to a multicast network management node configured to manage Internet Protocol (IP) multicast transmissions; and
means for delivering, to a multiplex stream multiplexer, the first and second sets of packets to be multiplexed into a single multiplexed multicast stream for transmission within the second and third multicasting areas, wherein the single multiplexed multicast stream has a third data rate that is higher than the first and/or second data rates.

40. A network device that is configured to multiplex a set of streams into a single output stream for delivery to a plurality of target devices, comprising:
means for receiving a first data packet associated with a first multicast stream for transmission in a given multicasting area and having a first data rate;
means for receiving a second data packet associated with a second multicast stream for transmission in the given multicasting area and having a second data rate that is different from the first data rate;
means for multiplexing the first and second data packets into a multiplexed data packet for a multiplexed multicast stream having a third data rate that is higher than the first and/or second data rates, wherein the multiplexed data packet includes (i) a first payload portion from the first data packet based on the first data rate, and (ii) a second payload portion from the second data packet based on the second data rate; and
means for delivering, for transmission within the given multicasting area, the multiplexed data packet to a multicast network management node configured to manage IP multicast transmissions within the given multicasting area.

41. A target user equipment (UE) that is configured to monitor one or more multicast streams, comprising:
means for receiving, on a downlink multicast channel, a multiplexed data packet that includes (i) a first payload portion associated with a first multicast stream and having a first data rate, and (ii) a second payload portion associated with a second multicast stream and having a second data rate that is different from the first data rate;
means for determining whether the first and/or the second multicast streams are relevant to the target UE; and
means for selectively decoding and processing the first and second payload portions based on the determination.

42. An application server configured to distribute a plurality of multicast streams to a plurality of target user equipments (UEs) in a communications system, comprising:
logic configured to determine a first multicasting area for transmission of a first multicast stream having a first data rate, a second multicasting area for transmission of a second multicast stream having a second data rate that is different than the first data rate, and a third multicasting area that overlaps with the second multicasting area for transmission of both the first and second multicast streams;
logic configured to obtain a first set of data packets that are associated with the first multicast stream;
logic configured to obtain a second set of data packets that are associated with the second multicast stream;
logic configured to deliver, for transmission within the first and third multicasting areas, the first set of data packets to a multicast network management node configured to manage Internet Protocol (IP) multicast transmissions; and
logic configured to deliver, to a multiplex stream multiplexer, the first and second sets of packets to be multiplexed into a single multiplexed multicast stream for transmission within the second and third multicasting areas, wherein the single multiplexed multicast stream has a third data rate that is higher than the first and/or second data rates.

43. A network device that is configured to multiplex a set of streams into a single output stream for delivery to a plurality of target devices, comprising:
logic configured to receive a first data packet associated with a first multicast stream for transmission in a given multicasting area and having a first data rate;
logic configured to receive a second data packet associated with a second multicast stream for transmission in the given multicasting area and having a second data rate that is different from the first data rate;
logic configured to multiplex the first and second data packets into a multiplexed data packet for a multiplexed multicast stream having a third data rate that is higher than the first and/or second data rates, wherein the multiplexed data packet includes (i) a first payload portion from the first data packet based on the first data rate, and (ii) a second payload portion from the second data packet based on the second data rate; and
logic configured to deliver, for transmission within the given multicasting area, the multiplexed data packet to a multicast network management node configured to manage IP multicast transmissions within the given multicasting area.

44. A target user equipment (UE) that is configured to monitor one or more multicast streams, comprising:
logic configured to receive, on a downlink multicast channel, a multiplexed data packet that includes (i) a first payload portion associated with a first multicast stream and having a first data rate, and (ii) a second payload portion associated with a second multicast stream and having a second data rate that is different from the first data rate;
logic configured to determine whether the first and/or the second multicast streams are relevant to the target UE; and
logic configured to selectively decode and process the first and second payload portions based on the determination.

45. A non-transitory computer-readable medium containing instructions stored thereon, which, when executed by an application server configured to distribute a plurality of multicast streams to a plurality of target user equipments (UEs) in a communications system, cause the application server to perform operations, the instructions comprising:
at least one instruction for causing the application server to determine a first multicasting area for transmission of a first multicast stream having a first data rate, a second multicasting area for transmission of a second multicast stream having a second data rate that is different than the first data rate, and a third multicasting area that overlaps with the second multicasting area for transmission of both the first and second multicast streams;
at least one instruction for causing the application server to obtain a first set of data packets that are associated with the first multicast stream;
at least one instruction for causing the application server to obtain a second set of data packets that are associated with the second multicast stream;
at least one instruction for causing the application server to deliver, for transmission within the first and third multicasting areas, the first set of data packets to a multicast network management node configured to manage Internet Protocol (IP) multicast transmissions; and
at least one instruction for causing the application server to deliver, to a multiplex stream multiplexer, the first and second sets of packets to be multiplexed into a single multiplexed multicast stream for transmission within the second and third multicasting areas, wherein the single multiplexed multicast stream has a third data rate that is higher than the first and/or second data rates.

46. A non-transitory computer-readable medium containing instructions stored thereon, which, when executed by a network device that is configured to multiplex a set of streams into a single output stream for delivery to a plurality of target devices, cause the network device to perform operations, the instructions comprising:
at least one instruction for causing the network device to receive a first data packet associated with a first multicast stream for transmission in a given multicasting area and having a first data rate;
at least one instruction for causing the network device to receive a second data packet associated with a second multicast stream for transmission in the given multicasting area and having a second data rate that is different from the first data rate;
at least one instruction for causing the network device to multiplex the first and second data packets into a multiplexed data packet for a multiplexed multicast stream having a third data rate that is higher than the first and/or second data rates, wherein the multiplexed data packet includes (i) a first payload portion from the first data packet based on the first data rate, and (ii) a second payload portion from the second data packet based on the second data rate; and
at least one instruction for causing the network device to deliver, for transmission within the given multicasting area, the multiplexed data packet to a multicast network management node configured to manage IP multicast transmissions within the given multicasting area.

47. A non-transitory computer-readable medium containing instructions stored thereon, which, when executed by a target user equipment (UE) that is configured to monitor one or more multicast streams, cause the target UE to perform operations, the instructions comprising:
at least one instruction for causing the target UE to receive, on a downlink multicast channel, a multiplexed data packet that includes (i) a first payload portion associated with a first multicast stream and having a first data rate, and (ii) a second payload portion associated with a second multicast stream and having a second data rate that is different from the first data rate;
at least one instruction for causing the target UE to determine whether the first and/or the second multicast streams are relevant to the target UE; and
at least one instruction for causing the target UE to selectively decode and process the first and second payload portions based on the determination.
